(19) United States
(12) Patent Application Publication
(10) Pub. No.: US 2013/0304527 A1
(43) Pub. Date: Nov. 14, 2013

(54) MOBILE SOCIAL-BUSINESS NETWORK

(71) Applicant: Alfred M. Santos, III, Los Angeles, CA (US)

(72) Inventor: Alfred M. Santos, III, Los Angeles, CA (US)

(21) Appl. No.: 13/894,404

(22) Filed: May 14, 2013

Related U.S. Application Data
(60) Provisional application No. 61/646,361, filed on May 14, 2012.

(51) Int. Cl. G06Q 30/02; G06Q 50/00

(52) U.S. Cl. CPC G06Q 30/0239; G06Q 50/01
USPC 705/5; 705/14.66; 705/14.13

(57) ABSTRACT

Systems, methods, machines and platforms are provided which detail a technique for utilizing a mobile social-business platform capable of building and managing a community of people so they can plan, coordinate and manage their lives in an efficient, social and financially beneficial way from a mobile device. Additionally, this application details a technique for building a network of select unique people's who will gain access to incentives from a vast combination of sources within their networks previously unavailable to them.

### RELATED APPLICATIONS

This application claims the benefit of and hereby incorporates by reference in its entirety, U.S. provisional patent application U.S. 61/646,361, filed May 14, 2012.

### FIELD

This application generally relates to systems, methods, machines and platforms geared towards connecting people on a unique social-business network designed for mobile devices. More specifically, to systems, methods, machines and platforms which can organize operations in order to maximize and gain revenues though various channels such as discounts, commissions, bonuses, offers, gifting, jobs, referrals, payouts, profit sharing and multilevel marketing by connecting select unique people and businesses on mobile platform designed for social-business networking, while ultimately making everyone's life richer.

### BACKGROUND OF THE INVENTION

Recently, industries have created mobile applications and platforms to assist with business. Being a newer field, there are still many industries where mobile innovation and technology have not caught up.

It is commonly known in the social and nightlife industries that people as a whole are unorganized when making plans to go out. People generally get excited to go out to the hottest restaurants, nightclubs, shows, games, shops, spas, gyms, vacation destinations, casinos, bars, events, lounges or the like of, no matter who they are or where they are from. For the purpose of this application, the word “venue” will be defined by any place or thing listed above, or any other place or thing people go to or do outside of their home for pleasure or business. People generally listen to suggestions from friends, or take recommendations from critics, online sources, app's, promoters and advertisements. They base their decision on where they will go to spend their evenings, weekends, vacations and hard earned dollars based off these opinions. Once they finally decide where and when to go, then comes the obstacle of actually booking a reservation, a room, a table, RSVP'ing for guest-lists, or coordinating any other social details. Often they must consult and utilize many sources to complete all the desired tasks before they can plan, coordinate and book a fun time out of their house.

This is usually not a big problem when dealing with common venues, but try booking a table or RSVP'ing for the hottest events in a major city and you will quickly find out that it can be nearly impossible. This can be merely annoying for someone out with friends looking for a good time. It could be embarrassing when walking up to the front door of a nightclub or restaurant with a date or potential client. It might destroy someone's ego to wait in line for the chance a door person might choose to let him or her in. It could even ruin a night when forced to spend an hour or more waiting for a table. At some venues, tipping a host or doorperson might help. Committing to spend a minimum dollar amount might buy you entrance. But at the hottest of hot places, not even these strategies will work. The bottom line is that if you don't know someone, or you are not a celebrity or supermodel, nothing will help you. If you are lucky enough to know someone, the amount of restrictions that person might put upon you often makes it not worth all the trouble. The amount of time and energy put into coordinating a night or weekend out, often leaves people feeling dissatisfied and frustrated. When you consider the total amount of time, energy and dollars spent for just another average social experience, it usually doesn't seem worth it.

In contrast to this, on the operations side of things, venues, event planners, hosts, owners, agents, managers, lawyers, marketing and promotion teams spend countless hours, resources and dollars on getting their hot brand seen by the community, and the select unique people they seek to frequent their venues. For the purpose of this application, these people working with and for venues will be defined as “operators” within the social activities world. Venues often spend upwards of twenty to fifty percent of gross revenues made to get the right people in their doors. This money can often be spent on planning, promotions, partnerships, software, parties, media, outreach, deals, offer, or any other form of advertising. Most venues tend to spend more then half of these dollars on operators that specialize in outreach to bring in select unique clientele. This clientele could range from young people, to wealthy people, to trendsetting tastemakers, to socialites, to celebrities, to beautiful people, but more often then not, it is spent on getting beautiful model'esque type women in their doors. Beautiful woman are typically the focal point in many of the industries discussed herein. This has most likely been true since the dawn of mankind, or at least since Helen's face “launched a thousand ships.”

These operators and venues generally understand that wherever beautiful women congregate, men and money will follow, and rest of the world will follow their lead. Like with any business, money is the bottom line. Many businesses have calculated that the more beautiful women they can wrangle, the more money they can make. The exact dollar amount spent on outsourcing to pull in the right clientele is not in the millions, but in the billions of dollars a year. This industry standard, just like the planning of ones social excursions discussed above, is highly unorganized, inefficient and archaic from a technological standpoint when compared with other industries in 2011. Any person who has worked in any aspect of these industries or who has attempted to plan a big weekend out will attest to this these problems.

Another problem surrounding many industries is the lack of an ability to directly connect with the “select unique clientele” of the world, such as the trendsetting tastemakers, socialites, celebrities, wealthy people and models of the world. The walls built around these people's lives by others are meant to protect them, but often, all these walls do is isolate these select unique people from the organizations and entities who wish to be in contact with them for the purpose of offering them gifts, promotions, travel, money and jobs, just to name a few.

These select people often have gatekeepers such as agents, managers, PR reps, lawyers and others whom work to shield and field any incoming offers. More often then not, these offers never seem to get to the actual person they are meant for and thus the system is flawed. Actors miss out on jobs from producers. Models miss out on jobs from clients. The rich miss out on promotions from companies and organizations that fight to get to these people. Companies, clients, and such often end up with a level of clientele they consider to be second rate, or not the select unique ones they desire. Everyone loses in this modern day system of politics, money and power.

There is a major disconnection across the realm of many businesses that can easily be lifted and reconnected through the use of the systems, methods, machines and platforms described within this application. It should be mentioned that the concepts disclosed within could work for any industry that seeks to connect with unique select people, or any unique group. It works for any industry that wishes to be in direct contact with unique people. Overall, connection is the biggest problem, or better said, the lack there of connection seems to be the biggest problem. Some people have the greatest networks, but they might not know how to utilize them to their fullest advantage, while others might do a tremendous job of utilizing their networks to earn a living. This application best analyzes new ways for people and businesses to network 100 through mobile means in efforts to improve life and business.

Overall, the process of people coordinating their excursions of leisure, pleasure and work are difficult at best and there is certainly no one system which does it all. The communication between operators or clients with clientele is cumbersome and nearly nonexistent.

### SUMMARY

The systems and platforms provided by this application solve these issues and many more. It provides an efficient means and solution for operators and clients to reach out to that certain select unique clientele they desire and it provides a means to directly and instantly incentivizes this select unique clientele in order to gain their return business. Operators will save on the typical exorbitant employee payout expenses within current systems and will be able to put a portion of that money towards incentives for return business of select unique clientele. This clientele appreciation will enable business life spans to grow which in turn will help all parties involved, and the experience will be simple and pleasurable instead of, careless and cumbersome.

For purposes of this application, the word “Mobile” or “Mobile Device” is defined as any device which someone might use everyday while on the move, something easy to carry, wear, or implant on a user, something that can receive and relay information wirelessly if desired, something other then a full scale P.C. such as a laptop or mobile desktop computing system, something more along the lines of mobile phones, pads, watches, glasses, helmets, implants, something that is truly mobile.

It is an object of this application to obviate or mitigate some disadvantages of existing practices.

In accordance with an embodiment, it is among an objective of this application to provide systems, methods, processes, machines and platforms for aggregating select unique people, and then connecting these people with other people or entities that are willing to incentivize them to do something In accordance with an embodiment, it is among an objective of this application to provide revolutionary systems, methods, processes, machines and platforms for businesses and people to directly reach out to select people to provide them with offers, incentives, or work of any kind, and for which allows these select people to securely accept or redeem these offers on a mobile.

In accordance with an embodiment, it is among an objective of this application to provide systems, methods, processes, machines and platforms with innovative mobile capabilities for specialized people to submit applications to desired and targeted companies or people that they seek to engage or work with.

In accordance with an embodiment, it is an objective of this application to provide new systems, methods, processes, machines and platforms with an ability to pay select unique people for checking-in to places from a mobile device

In accordance with an embodiment, it is among an objective of this application to provide original systems, methods, processes, machines and platforms with an ability to people for RSVP'ing. In accordance with an embodiment, it is among an objective of this application to provide first of its type systems, methods, processes, machines and platforms with a mobile solution for creating targeted offers for events, then effectively getting these offers out to a targeted people or an exact person of choice on a mobile device

In accordance with an embodiment, it is among an objective of this application to provide astonishing systems, methods, processes, machines and platforms for organizing and coordinating a society of the worlds select unique peoples by using a mobile solution as hub to facilitate this.

In accordance with an embodiment, it is among an objective of this application to provide original systems, methods, processes, machines and platforms for synchronizing information between one mobile platform and at least one other.

In accordance with an embodiment, it is among an objective of this application to provide paramount systems, methods and platforms for transmitting concealed communications between one mobile platform and at least one other, this is accomplished by relaying these messages via a controlled limiting hub specifically designed to limit personal detail exchange

In accordance with an embodiment, it is among an objective of this application to provide one of kind systems, methods, processes, machines and platforms for tracking, accounting, invoicing, billing, paying and collecting revenue on behalf of people, businesses and operators mobile devices.

In accordance with an embodiment, it is among the objectives of this application to provide systems, methods, processes, machines and platforms for a targeted social activities mobile app that can work as a personal concierge's service.

In accordance with an embodiment, it is among an objective of this application to detail unique systems, methods, processes, machines and platforms for providing people with a new option to be paid and spend money they earn from using a mobile platform by providing them with a loadable card that is linked to their account within a mobile platform.

In accordance with an embodiment, it is an objective of this application to provide innovative mobile device systems, methods, processes, machines and platforms that can pay select unique people from directly within a platform for socially promoting or marketing things directly from a platform available on a mobile device.

In accordance with an embodiment, it is among an objective of this application to provide novel systems, methods, processes, machines and platforms to help prescreen applicants in efforts to help sort them before sending out their personal submissions to the appropriate desired companies.

In accordance with an embodiment, it is an objective of this application to provide new systems, methods, processes, machines and platforms with a web and mobile ability to allow operators to refer business to other venues so that they can earn income for doing so.

In accordance with an embodiment, it is an objective of this application to provide modern systems, methods, processes, machines and platforms that can act as an agent, manager or any other sort of representative to clientele by providing all of the traditional services one of those representatives might normally provide a client, but via a mobile platform for personal devices in efforts to make the industry more efficient for representatives and clientele.

In accordance with an embodiment, it is an objective of this application to provide innovative systems, methods, processes, machines and platforms for creating the first ever true mobile business social network.

In accordance with one embodiment, it is an objective of this application to provide revolutionary systems, methods, processes, machines and platforms with an ability to reward and pay users to engage in social activities.

In accordance with an embodiment, it is an objective of this application to provide a targeted social media web and mobile app platform that a user can build their network on and get paid for it when their network engages in social activities.

In accordance with an embodiment, it is an objective of this application to provide new systems, methods, processes, machines and platforms with a mobile ability for using ones network and friends for social marketing to earn income.

In accordance with an embodiment, it is an objective of this application to provide original systems, methods, processes, machines and platforms for using ones networks to earn money for themselves by connecting select unique people with one and other.

In accordance with an embodiment, it is an objective of this application to provide extraordinary systems, methods, processes, machines and platforms for organizing and coordinating a society of the worlds select peoples on mobile devices.

In accordance with an embodiment, it is an objective of this application to provide innovative systems, methods, processes, machines and platforms for enhancing offers for promotions, giftings marketing and jobs, then allocating these things to targeted clientele on various platforms which can relay with handheld computing devices.

In accordance with an embodiment, it is an objective of this application to provide unique systems, methods, processes, machines and platforms for connecting the right people with the right companies for the right reasons and then collecting a payout for this service, all on a personal mobile device.

In accordance with an embodiment, it is an objective of this application to provide exceptional systems, methods, processes, machines and platforms for unionizing groups of people, particularly women and select unique people via a mobile platform and connecting them on mobile devices.

In accordance with an embodiment, it is an objective of this application to provide unequaled systems, methods and platforms for unionizing, incentivizing and mobilizing people on mobile devices.

In accordance with an embodiment, it is an objective of this application to provide innovative systems, methods, processes, machines and platforms for mobile devices platforms that can be used to revolutionize any sort of promotions and marketing business trough social viral marketing.

In accordance with an embodiment, it is an objective of this application to provide new systems, methods, processes, machines and platforms that innovates the way people plan, structure and coordinate their social activities with others.

In accordance with an embodiment, it is an objective of this application to provide pioneering systems, methods, processes, machines and platforms for allowing venues and clients to connect directly with select unique clientele they have historically strived to gain, or with targeted clientele of any kind.

In accordance with an embodiment, it is an objective of this application to provide new systems, methods, processes, machines and platforms that can allow people to coordinate all of their nightlife activities right from their fingertips on their personal mobile devices.

In accordance with an embodiment, it is an objective of this application to provide first of its kind systems, methods, processes, machines and platforms for RSVP'ing to guest-lists with real time sync to the master list on mobile devices, all of this is done by confirming, canceling, communicating and relaying information between operators of venues or clients and with clientele on a mobile device.

In accordance with an embodiment, it is an objective of this application to provide original systems, methods, processes, machines and platforms for creating a superior feature driven Opentable for nightlife services on personal mobile devices.

In accordance with an embodiment, it is an objective of this application to provide innovative systems, methods, processes, machines and platforms on mobile devices for securing an exact table of choice at a venue by showing a table floor map, or a detailed table list for users to choose from, in a way much like a picking a seat on a plane is done today.

In accordance with an embodiment, it is an objective of this application to provide new systems, methods, processes, machines and platforms for buying and selling tickets on mobile devices, all of this is done by confirming, canceling, communicating and relaying processing information between operators of venues or clients and with clientele on a mobile device.

In accordance with an embodiment, it is an objective of this application to provide imaginative systems, methods, processes, machines and platforms on mobile devices for placing an order for service at a venue via a personal mobile device, this is done by linking the needed parties together with proper abilities to communicate and process these orders, and in real-time if desired.

In accordance with an embodiment, it is an objective of this application to provide revolutionary systems, methods, processes, machines and platforms on mobile devices for securing VIP services of any kind at venues via a personal mobile device, this is done by linking the needed parties together with proper abilities to communicate and process these orders, and in real-time if desired.

In accordance with an embodiment, it is an objective of this application to provide extraordinary systems, methods, processes, machines and platforms for changing the way venues operate by implementing a mobile platform for handheld personal devices which can organize, coordinate and relay all operations in real-time, not just with company operations, but also with the clienteles needs.

In accordance with an embodiment, it is an objective of this application to provide systems, methods, processes, machines and platforms to be used on mobile devices for enhancing the way venues and operators manage and coordinate business in house.

In accordance with an embodiment, it is an objective of this application to provide unprecedented systems, methods, processes, machines and platforms for changing the way venues operate by implementing a mobile and web platform which can give a venue clarity to see exactly what each operator is doing, how much business they are personally bringing in, by providing an overall transparency to see what's happening with all employees and clientele, in efforts to save venues and clientele time and money.

In accordance with an embodiment, it is an objective of this application to provide new systems, methods, processes, machines and platforms with an ability to provide operators or users alike with an indicator and foresight for what to expect days and hours before going somewhere, this foresight can be provided by knowing how many people, particularly how many girls and guys exactly are planning on being somewhere in the future, it might even provide more detailed insight as to specifics about the people, thereby allowing people to plan accordingly and make decisions with confidence.

In accordance with an embodiment, it is an objective of this application to provide original systems, methods, processes, machines and platforms with an ability to provide people with an accurate indicator and foresight for where people are right this second, it does so by networking everyone together and then incentivizing users to check-in when they arrive, additionally it can pull data from other check-in sources to help build a more accurate hot meter or people traffic map based upon this aggregation of check-ins and information

In accordance with an embodiment, it is an objective of this application to provide new systems, methods, processes, machines and platforms with advanced and superior location based verification processes on mobile devices.

In accordance with an embodiment, it is an objective of this application to provide unique systems, methods, processes, machines and platforms of bartering services on mobile devices.

In accordance with an embodiment, it is an objective of this application to provide unparalleled systems, methods, processes, machines and platforms for creating, coordinating and managing a sales forces of people who work on personal mobile devices at their leisure, in doing so, a company can employee a mobile sales force team for any product on the platform.

In accordance with an embodiment, it is an objective of this application to provide extraordinary systems, methods, processes, machines and platforms for organizing and coordinating a wingman service on mobile devices.

In accordance with an embodiment, it is an objective of this application to provide extraordinary systems, methods, processes, machines and platforms for organizing and coordinating a dating service on mobile devices for a group of select unique people.

In accordance with an embodiment, it is an objective of this application to provide unique systems, methods, processes, machines and platforms for creating, growing and generating business from mobile devices.

In accordance with an embodiment, it is an objective of this application to provide the first ever mobile systems, methods, processes, machines and platforms which could connect users with company's willing to pay them for doing things they love doing and are probably already paying to do.

In accordance with an embodiment, it is an of this application to provide first ever mobile systems, methods, processes, machines and platforms which could process one, or all of the desired tasked discussed within this application directly from a mobile devices.

These teachings also include a modeling agency capable of conducting its core elements of business on a mobile device and an acting agency capable of conducting its core elements of business on a mobile device.

### DRAWINGS

FIG. 1 is a general flowchart of a broad example platform.

FIG. 2 is a basic wireframe of a sample mobile platform for social activities with a built in multilevel marketing system

FIG. 3 is sample view of a member user's profile.

FIG. 4 is a sample view of a sorted landing page.

FIG. 5 is a sample view of a listing page by popularity.

FIG. 5A is a sample view of a listing page by nearby.

FIG. 5B is a sample view of a listing page.

FIG. 5C is a sample view of an Events listing page.

FIG. 6 is a sample view of details action page.

FIG. 6A is a sample view of details action page for RSVP and TABLE.

FIG. 7 is a sample view of Confirm RSVP Terms and Conditions Page.

FIG. 8 is a sample view of details action page with Table Selector Action.

FIG. 8A is a sample view of details action page with Table Selector Action.

FIG. 8B is a sample view Sent Table Request Confirmation.

FIG. 8C is a sample view of a details action page with Full Service Table Action Page with Table Floor Map and Menu.

FIG. 8D is a sample view of a details action page for Macy's Model Search with Talent Submission.

FIG. 8E is a sample view of a details action page for Talent Submissions.

FIG. 8F is a sample view of a details action page for Buy-In, Sponsors, Invite.

FIG. 9 is sample view of a Who's Going Page.

FIG. 10 is sample view of an Invite Page.

FIG. 11 is a view of a Check-in Page with upcoming.

FIG. 12 is a view of a Locked Page.

FIG. 13 is a sample view of My Network of Friends.

FIG. 14 is a sample view of MLM or pyramid system for select people.

FIG. 15 is a My Network Activity Page.

FIG. 16 is an upgrade informational page.

FIG. 17 is a sample web Upcoming Events Page.

FIG. 18 is a sample Create Event Page.

FIG. 19 is two sample Table Floor Map Image Zoom Pages.

FIG. 20 is a sample flowchart for concealed communications relay.

FIG. 21 is a sample concealed email relay.

FIG. 21A is a sample concealed SMS relay.

FIG. 21B is a sample concealed three-way relay.

FIG. 22 is an administer overview.

FIG. 23 is an event view.

### DETAILED DESCRIPTION

The foregoing aspects, features and advantages of the present application will be further appreciated when considered with reference to the following descriptions of a few preferred embodiments and accompanying drawings, wherein like reference numerals represent like elements. In describing the preferred embodiments of the invention illustrated in the appended drawings, specific terminology will be used for the sake of clarity. However, this application is not intended to be limited to the specific terms used, and it is to be understood that each specific term includes equivalents that operate in a similar manner to accomplish a similar purpose. See the definitions within this application for further clarity if needed.

It should be understood that all illustrated preferred embodiment's detail the workings for mobile platforms, systems, methods and machines. However, it is often referred to as a mobile and or web-based platform. Some developers and designers might choose to incorporate a web-based counterpart that could perform some or all of the discussed workings. More then likely, some of the mobile platforms could have an added web-based counterpart that might have more features then its mobile counterpart. This counterpart might be a standard server type system, cloud based system, or full aspect web compliment, any combination of these, or something form of platform not yet known but able to support such systems, platforms, and machines. A large part of the innovative aspects within this application are focused at mobile devices and particularly handheld mobile devices. This should not be construed as limiting to mobile or handheld, but as focused on mobile with a possible other counterpart. It is important to provide diversity with platforms for systems, methods and machines to appeal to the largest market. This backend side of these mobile platforms might be accessible to users, administrators and partners.

The secondary purpose of this aspect is to give people the ability to access, create and control more detailed information and features that might otherwise not be accessible via the current mobile technologies. Additionally, a large part of the processing, synchronizing and managing of information could be performed and relayed to mobile devices from these backend complement units if needed.

In an embodiment of the present application, a general mobile or web-based platform is illustrated detailing the workings of systems, machines, and methods centered around social activities, and possibly the talent industries as well. Of course, while the examples and explanations are provided with regard to a few industries, it should be understood that the features and benefits of the systems, methods, machines and platforms apply to many other types of businesses as further discussed. It should be mentioned that the descriptions and operations provided are untraditionally listed in a semi-linear and non-linear manner. The description and operation of one or several figures is often mixed into the description and operation of other figures as these systems, methods, machines and platforms can be integrated with one and other to enhance each if desired so.

Before discussing any figures it is crucial to understand the differences between users within these platforms. Some of the platforms disclosed within function with at least two levels of users. General guest users, which as the name indicates would be a user who is not a registered or member user, and who might have limited functionality. The second type of user would be a registered or member user, which as the name indicates would be someone who was allowed additional access to the platform after meeting some membership requirements or predetermined criteria. Many of the platforms disclosed function as business social networks, or they combine to form an elite mobile business social network. It should be noted that a platform could function with just one type of user group, or multiple types, some discussed herein, and others not mentioned for sake of simplicity.

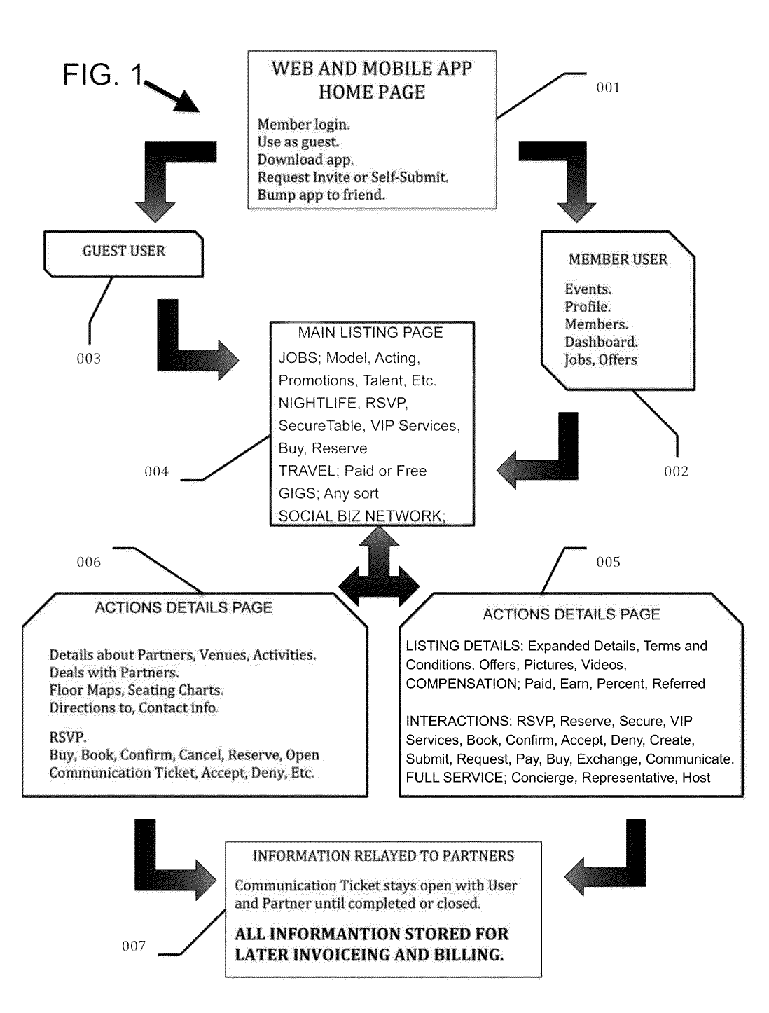

The membership requirements for each platform, system, method and machine vary greatly depending on the industry designed for. In general, each platform would have a slightly different application process. For the most part, the developer or designer (who we use interchangeably), for each platform, would set those criteria's. As a general rule, most of the platforms are business oriented and so the selected member users will usually be select people those businesses desire. For purposes of simplicity we lightly illustrate differences in those criteria's and systems. Submissions to become a registered or member user are illustrated in the beginning pages of FIGS. 1 and 2. FIG. 2 shows an overview of a system. A user opens the platform or web-based page and can sign on as member user by imputing their username and password, or they can enter the platform as a guest if that platform allows such access. Some rarer platforms might only have general guest access. We say rarer because this application is more focused on select peoples, this is a detail which makes it unique compared to other platforms. This is detailed in 001 and 010. On the home landing page, users will have the ability to apply for membership or registration. The difference in these users and the criteria to become members is crucial to discuss and understand in some detail.

For many of the platforms disclosed, particularly the ones with a means to earn an income for users, a user must usually meet some predetermined criteria set. In actuality, the criteria are set by businesses that are willing to pay these member users, so a developer might set the platforms criteria to meet such demands of businesses when designing their platform. For the nightlife, social activities and talent industries, which some of the platforms discussed within center around, these criteria are often very similar. In order to get a person paid for doing something that most everyone in the world would normally have to pay to do, they must be someone of extraordinary standards. A person with some physical, social, financial, intellectual, public or power aspect that allows them to stand apart from another person. It should be said that this is not always the case, but is a good rule to follow for simplicity of this application. Someone of the earlier discussed select unique people, such as the socialites, tastemakers, celebrities, affluent, wealthy and beautiful people might fit that criteria. These people are often the sought after select few of the world. The people most others want to know or be friends with. This is particularly true with beautiful people, more particularly with beautiful women. Beautiful people tend to be the center or core of these industries, but this is certainly not a requirement. People and companies will generally pay big money to be around these select unique people, in hopes to play where they play, do what they do, possibly get to know them, become friends with them, hire them, get them to endorse their brand, or just to be near them in general.

This application exploits this opportunity and focuses on organizing or centralizing all of these select unique people around a mobile hub, which in this application are its platforms. Then it unities these peoples with those others who are willing to offer them things. These things could range from money, to gifts, to products, to jobs, to discounts, to incentives, to travel, to offers of any kind.

For better clarity, we will be discussing the description and operation of FIG. 1, but we will often refer to other FIGs. to help with the explanation. FIG. 1 is an illustration of a general platform with systems, methods and machines to convey a simple mobile application as a hub or network for groups of people to review and partake on offers specific to them. We also discuss their possible web counterparts. This figure provides a rough outline that could be applicable to many industries but for the sake of this example we will discuss the platform and then explain the systems, methods and machines behind it in greater detail throughout.

The landing page for the Mobile or Web based platforms could have some basic core features in addition to any other designer desired features. In FIG. 1, a landing page for the web or mobile platform is illustrated by 001. The core features could include the ability to log in for members or known users. This is also seen in better detail in FIG. 2 as 010 and 012. Another core feature could be the ability for a guest to use the platform; this is also seen in 010. Another core feature could be the ability to download the mobile or web based platform. This would most likely be a web-based feature to download the mobile version but it could work for some web applications. Another core feature in both 001 and 010 could be the ability to request an invite or to submit an application to become a member or registered user. This would be useful for any system that wanted to accept certain people versus allowing just anyone to use their platform. This process could is better illustrated in FIG. 2 on 011 and its connected pages. It could also be useful to collect user information in a databank just the same as any other network or platform might. Another core feature could be the ability to bump or send the platform to a friend to invite them. This feature would allow a user to sent the platform to a friend, via email, text, Facebook or any other means a designer or developer felt useful. These core features would be the base for the landing page options for a web or mobile-based platform. In FIG. 2 there is an option for users to sign in using their Facebook accounts 013. This allows the users and their networks information to be pulled from their profiles to be stored in the databank. Not every platform or designer would have to use these features, but in the current market place, these seem to be the usual desired options. Designer flare would be used to build upon these core features. Other designers or industries might not need any of these features indicated for the landing page. They might not need a landing page at all. It could be beneficial to pass on this option for ease of use. This could speed up the process for the end user, which could be the desired choice for a designer.

As we follow along the wireframe in FIGS. 1, 002 and 003 are illustrated to show the potential core differences that could be offered as options for certain industries if they were desired. Member user 002 offers the ability to have a landing page or dashboard for registered users or members, also seen 035 of FIG. 2. In this field they could have the core options to list additional categories. A member or registered user could view their profile, preferences, menu, update, change and have any other common desired user options, this is illustrated more clearly in 028 and 029 of FIG. 2. Privacy settings are crucial for many of the systems and methods described within and will be discussed in greater detail later, but for now can be seen in 040 and 041 of FIG. 2. Another core feature controlled by designers is what specific things are offered or viewable to registered users versus nonregistered, a sample of this is seen as FIG. 12. This allows a guest to apply to unlock some additional features that only a member user might have access to. Some developers might include all aspects and features for all users. For this platform, both guests and registered users are dropped to the same main page 004. For ease and speed of use, 002 and 003 could be eliminated entirely if desired for a particular design, making 004 the main landing page.

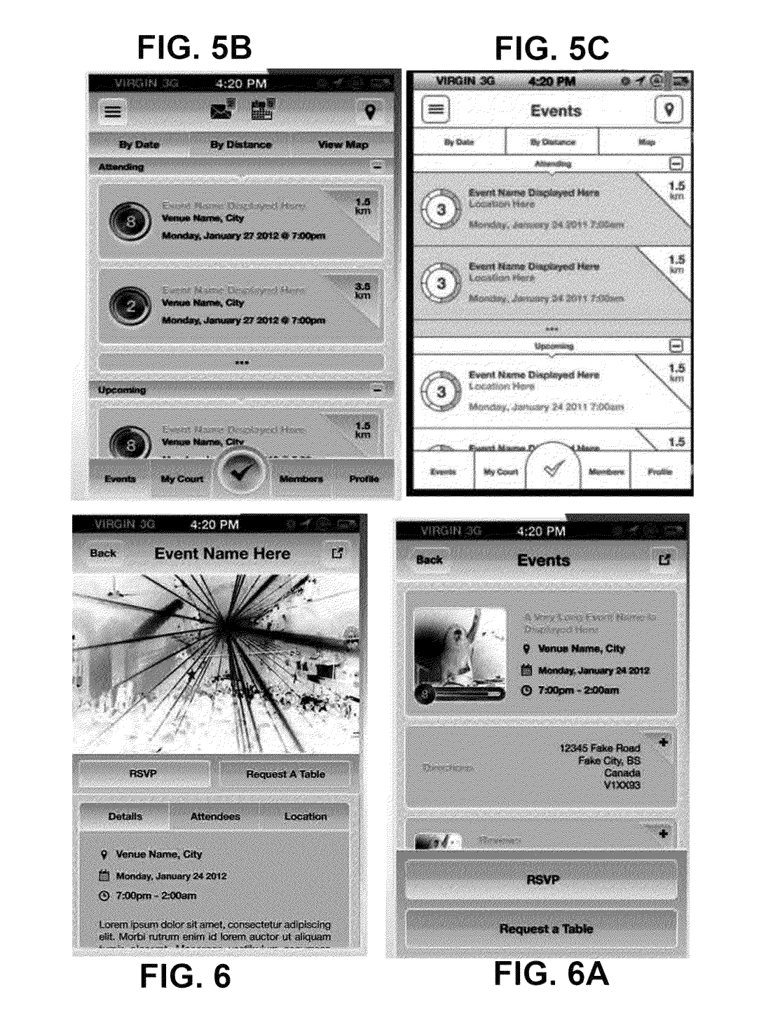

For example FIG. 1, main page 004 illustrates some nightlife, social and entertainment industry features with many capabilities not yet offered by many mobile and web based platforms. The platform will by default calculate the users location. This can be done by any common means, GPS, geofence, triangulation, towers, hotspot, near-field NF communications, Wi-Fi, previous locations, input field, or any other desired means. A user could select or input another desired geographical location as well. Once the desired location was ascertained, the user would be able to view all possible areas of interest within that location. For main area of interest page 004, we list example options such as clubs, discos, bars, lounges, shows, games, events, casinos, gaming, restaurants, spas, gyms, personal, offices, jobs, modeling, acting, talent, promotions, partners, and offers of any type. These categories could range from anything or anywhere people go outside of their home for pleasure or work, we call these social activities in this application. There are many systems and platforms that offer deals and discounts and ticket purchase abilities but none to coordinate and book users social activities with friends in one convenient efficient mobile platform which is what a version of this system does. Main page 004 is an example of general offers listing main page where a user could sort and view general details about offer listings. This sort of page is common in most platforms of any kind. Detailed variations of this offer listing page can be seen in FIGS. 5, 5A, 5B, and 5C.

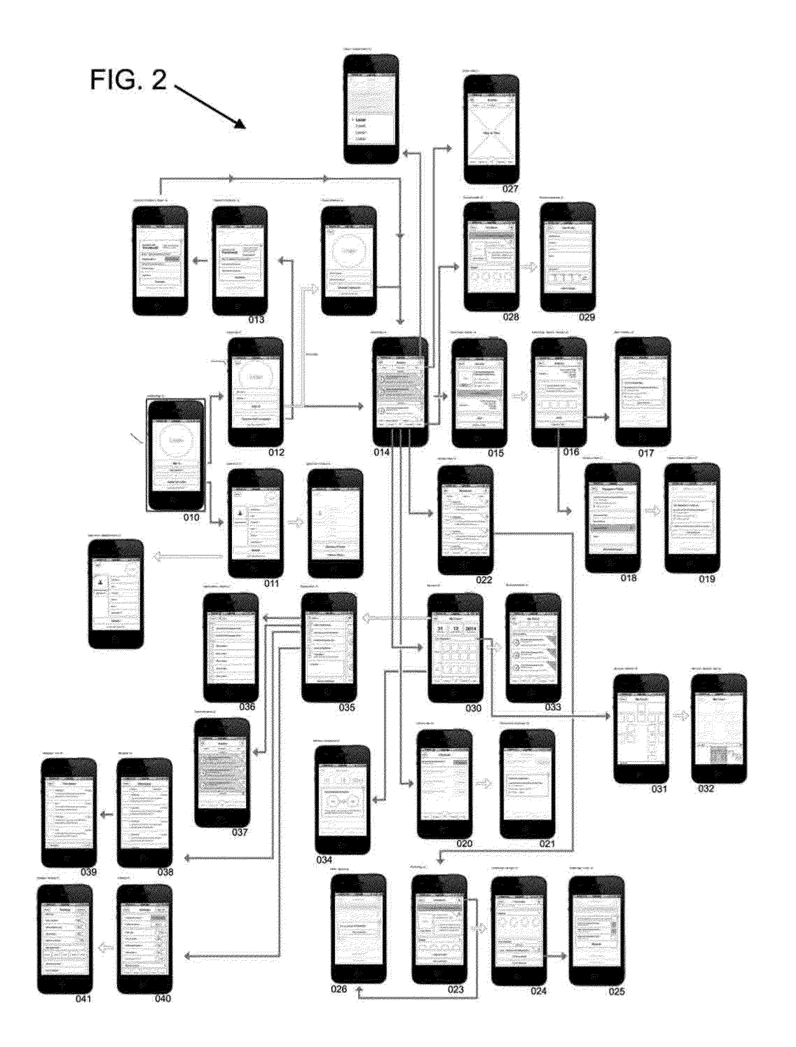

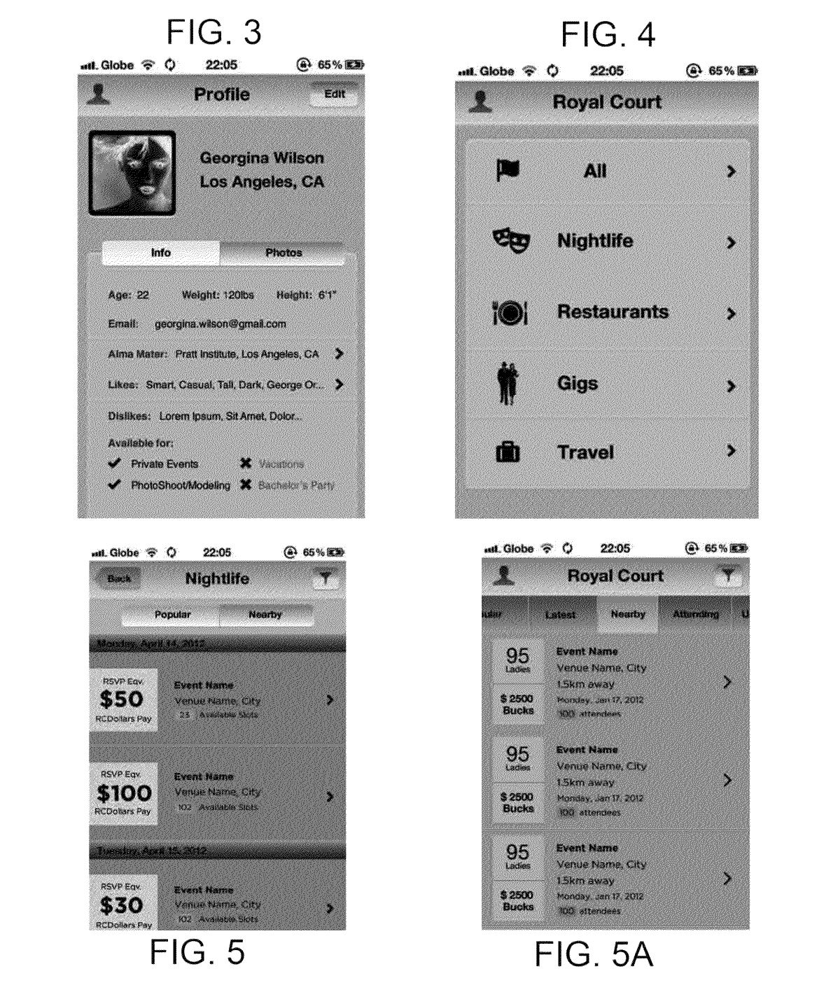

A feature to mention is the ability to sort all the categories desired. This would display, list or show certain aspects, tabs, or groups of activities. This allows a user to selectively review all or only some offers and activities. A general sort page might look like FIG. 4. Additionally, based off user preferences, they can control what they want to view and have access, or what the platform can send messages, invites and offers about. A version of this is illustrated on the bottom of FIG. 3, where it shows Available for: Private Events, Photo Shoot Modeling, Vacations and Parties. The member in FIG. 3 chose to be contacted for some offers, but not all.

A restrictive option to selectively allow or withhold listings or offers for users is key in some platforms discussed. Offers and listings that apply to people meeting certain criteria would be revealed only if that user met those criteria's. In essence, hiding listings that are not appropriate for them. The designer or the listing partner administering the post could choose the selected criteria. More on this later.

Depending on the user selection made on the main offer listing page 004, FIG. 5, 5A, 5B or 5C, the appropriate details action page would open. This option is common in most modern platforms. It is illustrated by 005 and 006 in FIG. 1 and is labeled Actions Details Page. Both 005 and 006 are similar, but for this platform we illustrate two versions of the same page. A few more options or details for a member user are shown in 005 versus a guest user in 006. This difference is a developer choice that might not be necessary but could be beneficial for selective offers and partners, or for select platforms. Before continuing it is important to understand why there might be differences for different users. Particularly why the listed offers on this platform are different and superior versus all other platforms.

Its a fact then when a person is presented with a choice between two equally qualified individuals for anything in life, they will generally choose the better looking one of the two. This is a general rule of human nature that falls back to Darwin's survival of the fittest. Business 101 teaches us that sex sells. Most businesses have embraced this and therefore spend large portions of their revenue using beauty as a tool to engage or bring in more sales. The backbone of these systems, methods and machines is no different.

Companies and people are always looking for promotional models, beautiful bartenders, hosts, assistants and even good-looking people to fill a position within a company. Generally speaking, a person might be more apt or prone to listen and hear a person they are attracted to versus someone they are not. Additionally, talent scouts are constantly searching for that next perfect face. Beauty, power and frame are sought after. Entities often pay big dollars to third party wranglers to round up beautiful people to bring them to a destination or event. This is common in the promotions and nightlife industries. Operators get paid to round up a nice looking group of people to come attend an opening of a casino, restaurant, club, hotel, vacation destination, events, parties, or the like of these social activities. Often, all expenses will be covered, such as flights, room, board, meals, drinks, party and petty cash. Sometimes unique people are paid to attend do these sorts of things, just to have some pretty or interesting people mingling about. Celebrity wrangling is very exclusive niche industry that is constantly coming up with ways to motivate celebs to do things or come places. Celebrities can instantly validate any brand. Many people have said it's not where you go, but who go with. Another version of that is, its not where you are hanging out, but it's who is hanging out with you. To view an amazing sight by ones self is great, but to view and share that same sight with a great group of people, is incredible. If a person had dinner at a restaurant that had lots of beautiful and famous people eating and having fun, they would be more likely to return for another meal. If a person stayed at a hotel or vacation destination that had lots of beautiful and famous people staying there, hanging out and having fun, they would be more likely to return to that hotel over another average hotel. If a person shopped at a store or business that was filled with lots of beautiful employees and every celeb in the world endorsed that company, they would be more likely to return to that store or business as a repeat customer. At fundraisers or charities, if people are surrounded by lots of beautiful, interesting and powerful people, they will most likely be having more fun and possibly a few more drinks, this might directly correspond the amount of money given when they open their wallets. For these reasons, select unique people can be paid for doing things everyone else might normally pay to do. This platform is a hub that brings all the select unique people together into one place or community that is centralized by the platform. Then it gets those same companies and people who spend all those billions each year to give that money to its members. With this platform, users would have access to previously unheard of deals and offers that have always been reserved for the rich, famous and “connected.” This platform connects the right people with the right people. The reasons for paying select unique people are limitless. The systems and methods behind the platforms which builds the databases of select unique users is what gives these platforms an advantage when negotiating with listing partners to get the better deals and offers then any other person ever could on their own. Think quality not quantity. This concept is one of the central elements that allow this platform to have so many systems, methods and machines that could be utilized to earn an income for people while expanding their personal lives. While doing so, it also opens a variety of better offers for everyone else in the world.

Getting back to FIG. 1, things that could be listed in 005 and 006 include general details like address, maps, phone numbers, websites, pictures, videos, marketing and other specific information. Details that one might find on a companies website. Other details could be potential job offers, castings, payouts from partners, percentage participations, discounts, specificities about deals, offers, jobs, events, floor maps, seating charts, menus, partners and any other offers that could be relevant for that particular platform.

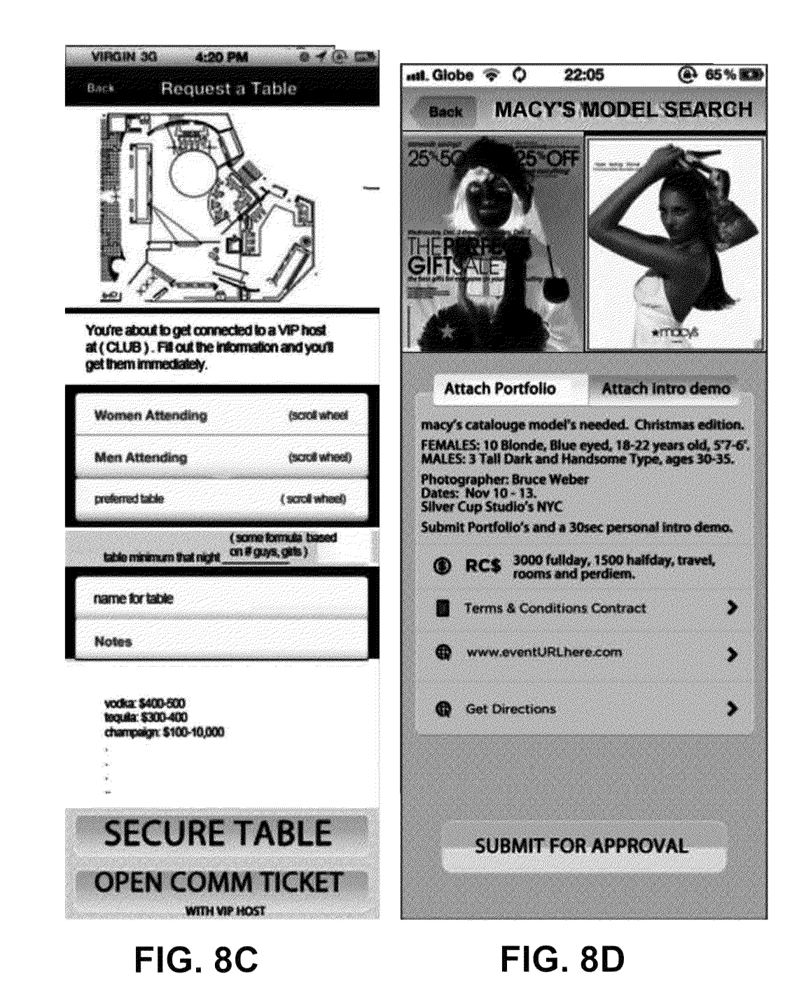

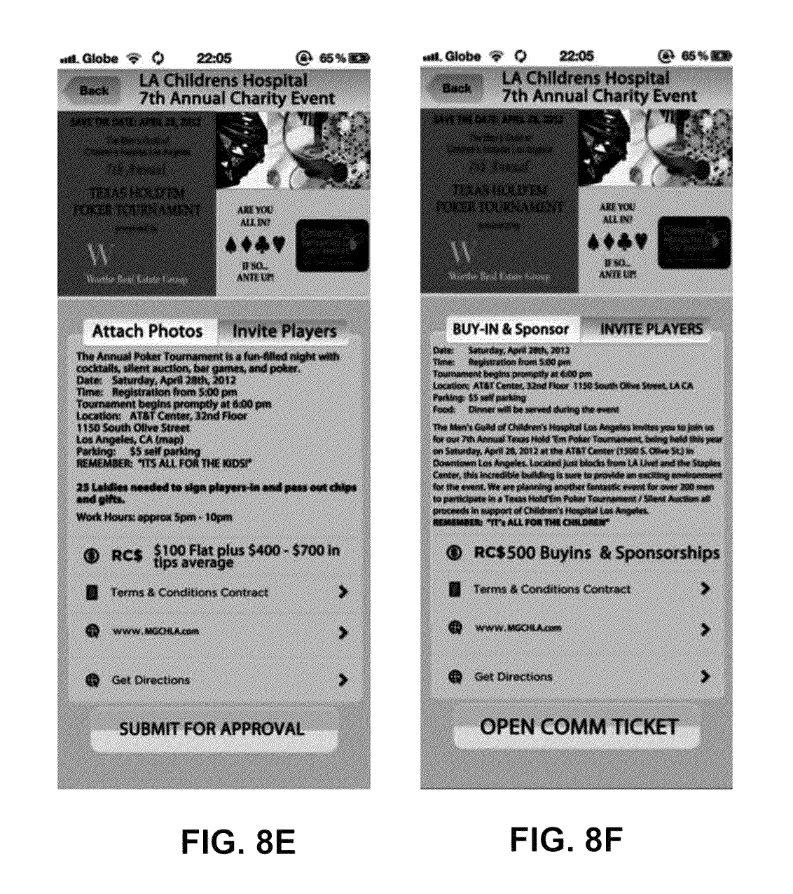

Another difference with this platform versus most others currently available within the industries specified, particularly on mobile platforms, is the ability to directly communicate or directly act with entities, companies and partners in a meaningful way. Some platforms offer general actions, but this platform offers a plurality of real actions with real people. This direct action ability is one of the key features that make it unique. Some example actions are to directly buy, book, confirm, cancel, reserve, RSVP, accept, deny, secure, submit, review, post, send, email, call, SMS, MMS, forward, invite, share, check-in, and any other action desired by the designer or partner. Other variations of this can be seen in FIG. 6A and FIGS. 8, 8A, 8B, 8C, 8D, 8E and 8F. FIG. 6A offers the ability to RSVP or Request a Table. FIGS. 8, 8A and 8C allows a user to view a zoom able table floor map, and then select an exact table of choice, see the average costs of that table depending on their party size, view menu, and then submit that table request to the exact person in charge of tables for the exact night the user indicated. Think OpenTable but with much greater functionality. FIG. 8D is a Macy's Catalogue Model Search Casting Page, with actions of Attach Photos, Attach Video and find out details, then submit all the needed information the client for review or approval for the job. The client would have direct book capabilities or other abilities such as request for casting, audition, or any other common actions within that industry. These features could range greatly to meet the needs of any full service agency. FIG. 8E illustrates an action page that enables users to attach photos for approval from the listing partner in charge of hiring twenty-five ladies. An example of how the direct book action might work is illustrated. The listing partner would review the submitted ladies and then could choose directly from the submission and book the ladies directly from within the platform by confirming them, or offering them the job which then they could confirm. The ladies could review the terms of contract and accept the offer once approved. The listing partner might also request to meet several in person at a casting. This can be conducted through the platform as well. FIG. 8F is an example of a promotional invite action page with abilities to Buy-In, Sponsor and Invite friends. Action Details Page 005 and 006 offer these sorts of true action abilities and true communication abilities with “the” exact person you should be speaking with. In 005 and 006 a user would decide whether they want to act upon the action links and buttons or go back to review other areas of interest. Information Relay 007 illustrates a sample of what would happen if a user decided to act.

Outside of the ability to directly act, a user can text, call or email as they can with most platforms. What's unique with this platform is that a user can open a communication ticket with “the person” in charge of a specific listing offer. That communication ticket, or message relay that could stay open between the two parties for as long as needed, or until they could complete their transactions. It instantly and securely connects the user with the exact person in charge for whatever it is they desire to accomplish via direct mobile-to-mobile communication. An example of this is illustrated with Open Comm Ticket on FIG. 8C. On this request a table page, it would connect you directly with the head host in charge of tables for the night you desire by opening a communication ticket. On FIG. 8F the open comm button would put you in touch with the listing partner directly in charge of sponsorships and player buy-ins by opening a communication ticket. Examples of this are illustrated in FIGS. 21, 21A and 21B. After viewing all of the details in any action details page, the user may decide to act or communicate. By doing so, they might be taken to an additional page or tabs that might have more options or features. They would be able to fully transact all of their business right there with as little as one click. In the case of billing, charging or paying, those tasks could be finalized and sent along through the platform or system for processing and completion. These processes have become standard for most apps. Users can link accounts and credit cards as well.

Generally speaking, most of these communications would be sent to a central hub where they would be processed, relayed and then synchronized to the appropriate persons platform. This hub might be a typical server type-processing unit, a cloud type based unit, or any other desired processing relay unit.

One skilled in this art can imagine how a platform of these sorts along with the proper systems, methods and machines could be utilized to work in many industries. The industries that immediately spring to mind with a lack mobile based solutions are those pertaining to the nightlife, social and the talent industries to name a few. Most of these fall under the umbrellas of marketing and promotions. FIGS. 1 through 12 indicate different versions of platforms specific to those industries. Not only do these platforms provide users with a much greater diversity of opportunities, but they also allow some members to earn revenue while doing so. In FIG. 2, we are going to look at a version of many of these platforms combined into one based around a social network which focuses on getting select member users paid.

In discussing this platforms diversity lets look at the example of entertainment, such as the modeling, acting, promotions, marketing or talent industry. Clients looking for talent for a job can post work to a mobile platform like this, via a mobile or web platform. Talent on the platform can review the job offer or requests. The hub and or platform of the system could if desired isolate the right users or members, or in this case talent who the client seeks for that specific job. It can become only visible to those members who fit the determined criteria of that job. It could even isolate one exact user so that a listing partner might offer them something. It might be possible for all users to view it, but only the users who fit the criteria would have the ability to act upon the listing as requested within the clients details. The members could submit themselves for the job directly from their personal mobile device in 005 and 006. They could send pictures and video. They could RSVP for a casting call. They can confirm a booking. A client might be able to review this information and then confirm a certain individual for a casting, job or offer. A client would be able to isolate exact members by entering criteria options, then browse through the appropriate members. They might contact certain members of choice or invite them to a listing where they could find out details about the user specific offer.

Examples would be Macy's hiring a model, or a model hiring a photographer. This is just one area of industry where this sort of platform can isolate select unique users on a mobile as well as server or web based platform. Not only is this the first platform to offer this as a mobile means but it also does away with the need for agents or other guardians acting as the middleman between the two parties. This convenience allows for more direct means of communication and faster relays which is an overall improvement within “the Industry” as a whole. It can also save talent and clients on third party middleman charges, such as agents or their like.

In fact this platform could be reversed for talent looking for proper representation. They could submit themselves to the proper channels while uploading pictures, video, demo's or performances of any kind directly to the central hub. This information could be sorted and sent out to a plurality of “proper” representation. This saves time and money rather than doing it the old fashioned way, by mail, email, or web submissions. There is no mobile system or platform out there that specializes in submissions on the mass level to unique talent representatives via a mobile platform from mobile devices or machines. As markets shift more towards mobile, this will become a more common solution. This basically acts as a mobile talent scout. The ability to scout for new talent on a mobile platform of any kind is massive. Providing both the user and the representatives with access to many more options. Mobile devices in malls, parks, stores or street corners might accept submissions of any kind, which could then be processed and managed by the hub, and then passed them along to the proper representatives. Another common system with casting calls for film and television is actors putting themselves on tapes and sending these tapes, CD's, or web links to casting directors, producers, directors, or their like. This could now be done via a mobile platform and without the need for the traditional middleman. This mobile search, selection and submission system could open a whole new industry in and of itself. The talent search and casting could be forever changed. The method of combining a mobile platform and this sort of system is dramatically more efficient for both the user and representatives. This is true for business scouting of any kind. The submissions, talent and scouting businesses can flourish with a mobile platform to centralize and navigate all coordination. With a centralized way for potential people to submit themselves to others through a mobile means is revolutionary. From handheld devices, to mobile stations or booths, people can submit themselves to many or hundreds of all in one convenient place.

Another area of interest to discuss in detail would be the gifting and advertising industries. Companies pay a lot of money to have their products used by the “right” people. These people usually might be celebrities, socialites, tastemakers, athletes, beautiful people and the rich and powerful. These companies usually pay money to other companies that specialize in getting products into the hands of these select unique people. The goal is usually to have these select people photographed or seen using their products. This is considered a sign of endorsement or approval of these select people. This translates to direct advertising for these companies. One picture of the right celebrity using the right product could earn a photographer ten million dollars, and a company much more in sales of that product.

A platform like this along with a system and method described here could help companies get their products straight into the hands of these select people. Some traditional ways of getting these products into the right peoples hands is through launch parties, gifting suites, PR reps, outreach and personal channels. A version of this platform with the systems and methods described can be utilized by companies to post their products that they are gifting, paying people to use, looking for endorsements, looking for talent for a commercial, or anything of this sort. They could post their products and offers to the platform where these select unique people would have instant and direct access to these offers first hand. There would no longer be the need for outreach or third parties to be involved. People would not have to leave their house or speak with anyone to see and receive these offers. This would not only save companies lots of money, but it would also give these select unique people access to a much greater diversity of products and offers which they might normally not have access to. This is beneficial to both the user as well as the entities and corporations trying to get there brand, venue, or products out there. It could be for something as simple as a new hot restaurant looking to get models into their space, or it could be Mercedes looking to gift their new hot car to the right celebrity.

The most common of way of directly getting product in select unique peoples hands is gifting suites. In this new version of promotions, marketing and gifting, the partner can post an offer to the mobile platform. They can detail what they are offering and what they require in exchange from the user. Usually companies are looking for a picture of the select unique user with their product. A user could agree to the terms and accept the offer. The product, or services, or offers could be delivered, or set up for exchange, or work. If it was something as simple as a picture, the user could take a picture of themselves using the product and then send the photo to the listing partner directly through the platform. Or they could allow a photo to be taken upon delivery. If it was a job, a commercial or personal showing that was required, those details could also be exchanged and relayed directly through the platform. They could also be passed along to a person's representative for handling.

If there were monies that needed to be exchanged or paid in or out, lets say for an offer that paid a user to do something. That process could be handled by platform for all billing, accounting and paying. Clients and users can arrange payment and billing through the platform for ease of collections and payments for both parties. The platform might automatically invoice the client on behalf of the talent. The talent would be electronically paid via the platform, more on this later.

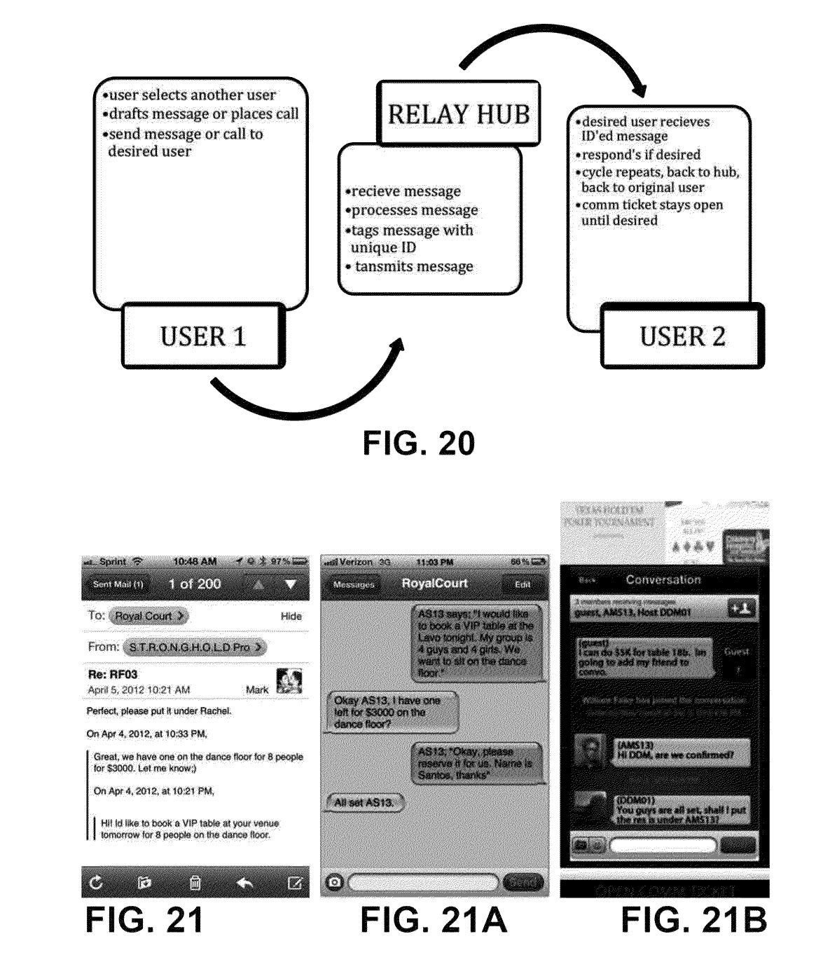

This system could save millions a year for companies and or people who pay others to do this sort of service for them. It could also earn people millions a year in direct product, incentives and money. It saves time and provides a direct means for both parties to interact directly but still allows the users to keep themselves and their contact information private and personal. Most, if not all of the communication could be carried out via the platform or through relayed communications protected and concealed by the platform unless both parties desired otherwise. This is illustrated in FIGS. 20 through 21B. More on this later.

This could work for the commercial industries, personal appearances, hosting, performances, promotions, gifting, modeling, acting, producing, directing, writing, dancing, singing and the list is endless and ever growing. These sorts of platforms can provide a whole new outlet for marketing. If a listing partner wished to offer these things to a certain type of person, based on their looks, wealth, power, job, education, network or influence. What if they wanted to offer something to women between certain ages, certain heights, and with only a certain hair color or eye color? For example, lets say Maybelline has come out with a new eyeliner they wish to sell, discount or gift to young beautiful fair skinned girls with blue eyes. Because this is their core buyer for this new product and because they know that if the best looking young girls in this market are wearing their new product, that their product would have better chances of blowing up within the young community of fair skinned women. So they might list the eyeliner at half off for any young ladies that met their exact specifications. They might even give away one thousand units of the product on a first come first serve basis. The terms of the deal might be that the young ladies must share the offer on their Facebook's if they accept. This form of social marketing is taking over the industry. There are an infinite amount of reasons companies are fighting to get their products into the hands of certain or select groups of people.

Depending on the platform developed, the databank within a platform has the ability to access personal details of its member users, their height, age, weight, where they live, where they go, where they like to party, who their friends are, pictures, bio's, resumes, employers, and many more personal details then a general user social network like Facebook might be able to obtain. Or an administrator might do this. To become a select unique member, one must submit all of this relevant information in order to be identified when isolated from all others. The backend systems could be programmed to sort through all of this information, or to crawl the web and friends information to determine any missing information needed to make this determination. It might automatically approve applicants based upon the pieces of information it was able to verify. This bank of personal information is valuable to companies trying to get their products into the right hands. It is valuable to nightlife and promotions operators who seek to have as many beautiful women show up as possible. It is valuable to talent scouts, representatives and employers. Information is valuable to almost any company or entity. Companies like Google and Facebook are valued in the billions of dollars not because of their generic platforms, but for their databases and banks of information. At least one of the platforms disclosed here operates similarly, but with one major difference, it has much more accurate user information and details which allows for much more user specific offers, deals, searches, jobs, for its listing partners and users alike. The platform could if desired narrow offers to a specific user. This ability to isolate unique specific users is efficient and beneficial to all parties involved. Additionally, this databank of information has the unique ability to be constantly updated. So information is relevant, real and precise. Organizations, entities and people are constantly looking for the right people, this unique platform and system has the ability to provide direct access to these unique people without having the need to involve a middleman which could be expensive and far less efficient. The membership criteria and selection process is one of the elements that makes this system unique. To provide an example that more closely relates to the platform and system illustrated in FIG. 2, lets imagine Swedish House Mafia was throwing a private show and they wanted one thousand blonde hair, blue eyed girls, between five foot five and six feet tall, and between ages twenty three to thirty. That listing can be posted on the events page, the platform can isolate and reveal this listing to any women who fit these criteria. Or it may post it as a public view for all to see within this community but only provide the ability to RSVP for the women who fit those specific criteria. Or it may list it and in the listing say only the women who fit this specification should RSVP for the show. Maybe they will pay these select women to go instead of paying others to wrangle them. The companies know that if they could throw a show with a thousand beautiful ladies that fit that description, then they might be able to sell tickets for five times as much to men who want to see this epic event. Maybe Swedish House Mafia will be transporting any woman who fits these criteria from certain cities for free to the show. The options are endless. But again, this demonstrates this sort of platforms effectiveness to isolate exact unique users and its ability to list offers, jobs, deals for specific unique users. This is efficient, cost effective and could even earn an income for some users. One of the most exciting elements about a potential system and platform like this is its mobile capabilities. With people using mobile solutions more and more, this is an ever-growing industry. From the relaying of the information, to the receiving and viewing of the information, to the listings and communication between the parties, it can all be transacted through a mobile platform.

A guest user might have less details or options then a member user. In a version of the system and platform illustrated, a guest and member user could both RSVP, both book table service, prepay minimums, or both accept an offer, but member users might have the ability to be paid for booking tables or sales, RSVP'ing, showing up places, bringing friends along, accepting offers, doing things, taking trips, accepting jobs, referring friends to partner businesses, bringing in other friends or partners, or the like. This first of kind ability to pay people for doing things they already love doing is unique to this application and its platforms, systems and methods.

Companies pay people who can bring the right select people out to places, to taste their food, to see their stores, to shop at their shops, to sell their products, to work for them, to party at their venues, to be at their parties, to go their events. These people wranglers who specialize in this generally command one to thirty percent of sales or monies made by a venue that night for bringing their select groups of people. They also might command a handsome base pay. Generally, these invited people go to these sorts of events and parties with the hopes of having a fun day or night out. They probably don't realize that the same person who invited them is making a lot money because they showed up. Whether it's a beautiful woman to a party, or a celebrity to a red carpet event gifting suite or a table buyer to a club. With this system and platform, the companies or entities that were paying this money to a third party wrangler, can now post this same offer as a listing to the exact people they wish to have show up. By cutting out the middleman, they save money and can now offer the select unique people they seek incentives in the form of money, gifts, vacations, discounts or any other conceived incentive. The same people who they wish to have show up to their venues, events, parties, or offers can now have access to far more offers and deals then ever before. Additionally, now those people can be forced to promote this listing if they want to accept the offers. The terms and conditions might dictate that they have to invite at least five friends on the network and share it on Facebook to receive the incentive. Listing partners can now have a much greater database to attract rather then being confined to their wrangler's personal channels. Users can collect that same money that was going to be wasted on hiring the wrangler to bring them in. Now, users can be paid for doing something they were already going to be doing tomorrow and for something they already did yesterday. All billing and payments can be handled electronically from within the platform.

The average young beautiful woman might go out to dinner with a few friends, then she might stop by a show, game, bar, lounge, party, or something, and then she might head out to club, disco, event or some other social activity. That is two or three different places in the course of a night. The average cost of valet major a U.S. city is ten dollars. If she were going to three places in one night, it would cost thirty dollars just for and gas. That does not include the cost of drinks, food, tickets, or cover charges. This woman's options of places to go are only as broad as her personal channels of information. To attend any great party, event, show, or anything, you must know someone to be invited. With a system and platform like these, the beautiful select woman does not need to know anyone. Now, with a platform on her mobile device like those illustrated here, she might RSVP for a comped ladies dinner. She might RSVP for free show where everyone else had to buy tickets. She might RSVP to party at the hot club that night. At the end of the night, she still would have paid the same thirty dollars on gas and parking, but since her meal was comped with her sexy girlfriends, since her ticket and drinks were comped at the show, and since she got paid twenty dollars for showing up to the hot club, her net cost of the night was ten dollars versus several hundred dollars she normally would have spent. More importantly, she didn't have to do anything to find these offers other then use the platform from her mobile device. Maybe she RSVP'd to an event that was paying beautiful women three hundred dollars to come and spend at least two hours there. So at the end of the night she did all the things she normally would have done on an amazing night out, but she actually came home having earned three hundred and twenty dollars for it. This is the first platform with systems and methods that directly pays people for doing the things they already love doing. Additionally, most beautiful women know a wealthy man or two. If that wealthy friend of theirs decides he wants to take the woman out that night and book a VIP table at a hot club. The woman could utilize the platform to book the table and she could be paid whatever the referral payout percentage offered by that partner might be, just the same as an operator would if they sent a table to a venue. The average VIP table ranges from one to ten thousand dollars. The average payout for tables is ten to twenty percent. If this women were to incorporate that into her night out, she now had a free dinner, then got paid three hundred dollars at the event, then went to the club and made twenty dollars plus ten percent of the table her friend bought. She probably ended up making anywhere from five hundred to fifteen hundred dollars for the night. She didn't buy anything, she didn't sell anything, she didn't actually work, she just did the same things she was going to do, but because she submitted herself as a member and was pretty enough to be accepted, she had access to all these amazing benefits. The venues and operators are happy they didn't have to do much to get her to show up. Her friend was happy he didn't have to call, text, email, Google, or Facebook twenty people to find out where to go or to book a table. The platform did all the work for her, plus it provided her with an incredible night out and got her paid for it.

Looking at the nightlife and promotions industries specifically, one can generalize and say that they both thrive off one major asset, beautiful women. The more beautiful women that are at a party, the more men show up to party. This directly translates to the highest number of sales. With lots of alcohol being consumed and lots of sexy people mingling, this directly translates to a top night out with big revenue dollars generated. Generally speaking, the more beautiful women at a party, the better the party, for both men and women alike. The good portion of the money paid out from venues in costs goes to the operators or people who can wrangle and bring in beautiful women. An employees worth or value within the nightlife and promotions industry is directly based on how many people they could bring out to party, or how many tables they could sell, or by the quality of people they could wrangle to come out. Quantity, sales and quality are the formula used by all venues to determine an operator's worth or compensation. Most hosts, wranglers or promoters are paid five to forty percent of whatever sales they can generate. They are also paid per person, or for how many people they could bring out. They are paid for bringing that select clientele discussed earlier, particularly beautiful women, socialites, celebrities and tastemakers.

FIG. 2 will illustrate more closely how the combination of a systems and methods along with a platform can perform all of the discussed tasks individually, it also illustrates how they can be combined into one mobile business social network which can be implemented to earn a user an income. This applications new methods are not only different because of its unique and innovative ways of combining many systems and users, but also because of it's ability to bring together select unique users and systems into a one of a kind network that can build members lifestyles while earning them an income.

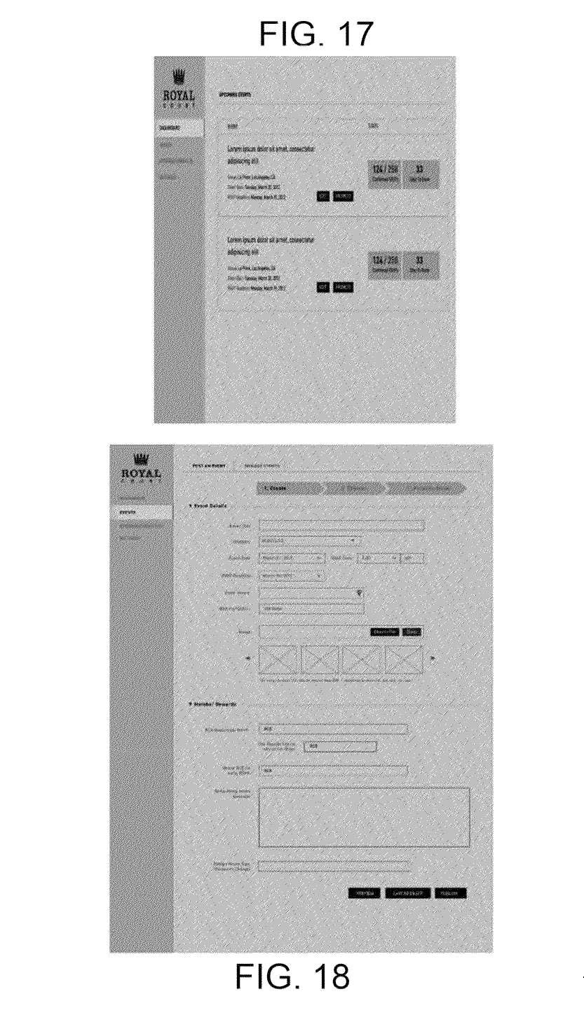

For the slightly more focused platform shown in FIG. 2 the user would download the platform the same as they would any other. Once installed on a computer or mobile device, a user would launch the platform. At launch page 010 a user could choose to sign in as a member user, or could continue as a guest user. An additional button would provide the option to apply for invite. This button would allow a guest user the chance to submit themselves to the platforms administrators for review. More detailed user information can be input in 011 and relayed to the administrators for them to make their membership decision. These details could be the basic general questions asked by most member enrollments platforms. For the purpose of the platform demonstrated in FIG. 2, the administrators chose to require name, age, location, email, phone, Facebook and photos. The user would then press the submit button to transmit this information for his or her membership submission. Once initially reviewed, potential members might be asked to fill out a much more detailed membership form. For the platform in FIG. 2, candidate members details would include basic physical attributes, height, weight, age, hair, eyes, race, languages, education, employers, representation, references, desired jobs, areas of interest for both personal and professional, disposable income, lifestyle preferences, and any other desired information. A user could sign in with their member info or could connect through Facebook as shown in 012. A user would input their Facebook sign in information and then click connect 013. The platform and system could offer the standard Facebook approvals to download user information and others. However the user logs in, they will all be directed to the main listing page 014, other versions illustrated in FIG. 5 through 5C. Main listing pages would give users the options to view and sort any and all partner listings and offerings. This page would be similar to that of 004 in FIG. 1. These listings could be sorted by date, distance, location, pay, free, vacation, work, deals, offers, or any other way the designer might choose. The sort button is located on the top left of 014, better seen in FIGS. 5B and 5C. Another version of a sorted listing main page is illustrated in FIG. 4. Basic information is illustrated for each listing including its distance from the users current location. Map view 027 provides pin drops for reference to the user. A user can view listing all across the U.S. or world this way. They can see general details about listed offers. Some of these details might include how much a listing might pay as shown in FIGS. 5 and 5A. They might also show how many people have RSVP'd already and how many available RSVP's still remain such as in FIGS. 5A, 5B, 5C and 17. A user can scroll through the listings or search for a particular one or type. Many of the concepts discussed in this paragraph are fairly standard these days. This particular platform and system gets far more complex and unique from this point forward.

If a user finds a listing they are interested in, they can click on the listing. This would connect them to an Action Detail Page such as that of 015. These sorts of action detail pages provide two major functions, one is details, and the second is actions. The details might be any relevant information that a listing partner might need or want to convey in a listing such as dates, times, contact numbers, maps, addresses, directions, emails, websites, directions, photos, videos, music, links, reviews, offers, terms, conditions, or any other relevant listing information needed to convey the offer. The second function is actions; these actions are where most of the users inter-actionable abilities with listing partners are located. Examples of these action detail pages are illustrated more clearly in FIGS. 6, 6A, 7, 8, 8A, 8B, 8C, 8D, 8E, 8F, 9, and FIG. 10.

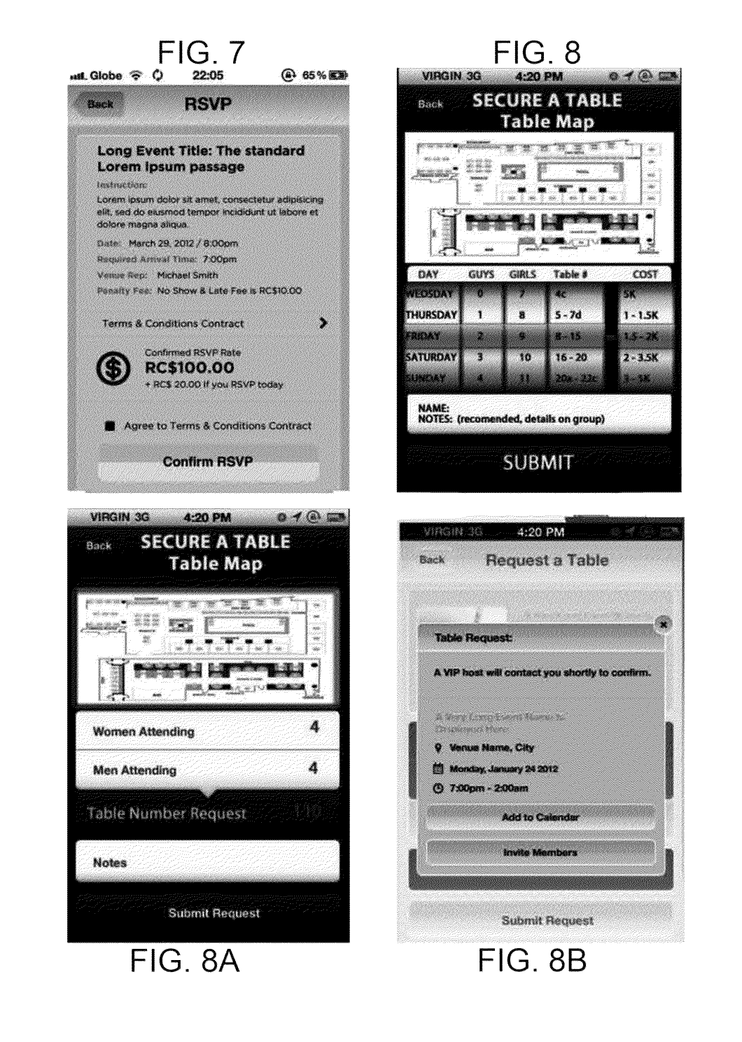

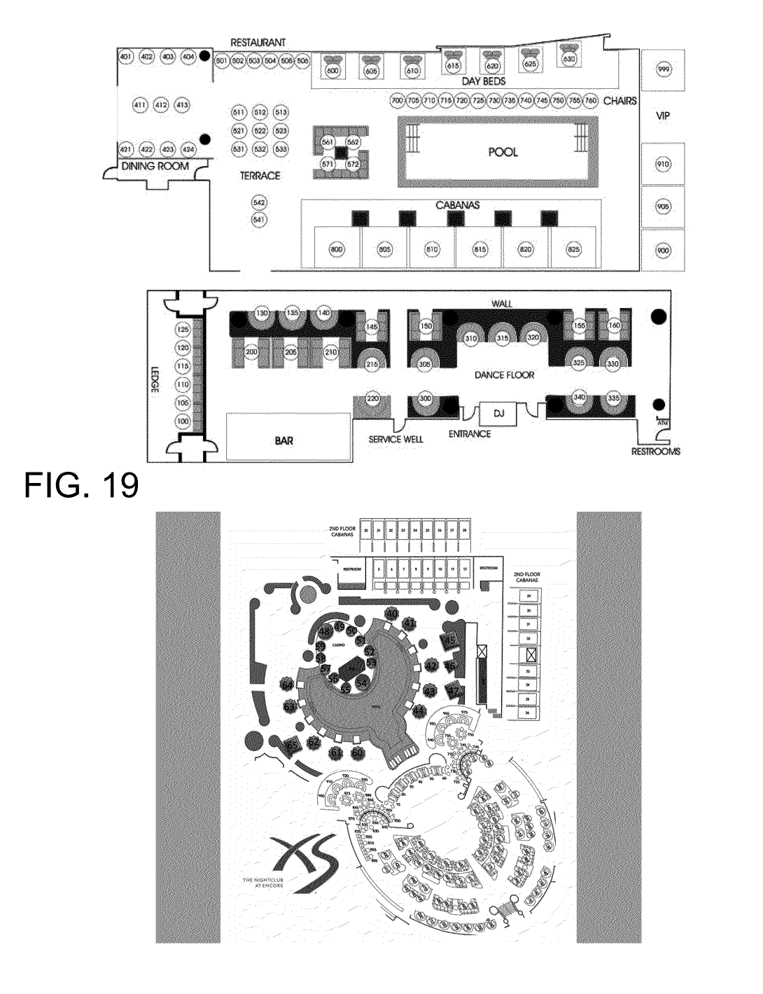

As discussed in FIG. 1 and earlier paragraphs, the direct actions could vary depending on the sort of platform developed by a designer. For FIG. 2, we are looking at a platform that integrates many systems and users; therefore it has a vast array of actionable abilities that allow users to directly interact with listing partners in a meaningful way. Lets look at the better illustrated examples provided. Action details page FIG. 6 is an example of a nightclub. All the relevant and needed information to promote this event is listed here. A user would have the ability to RSVP for the event. In FIG. 2 this is seen as 016. By pressing the RSVP button, their personal information would be transmitted directly to the listing partner. A developer might add the extra confirmation page as seen in FIG. 7. This would allow a user to review the terms and conditions of the offer and then confirm their RSVP. Action page FIG. 6A has the same RSVP action, but it also has the Request a Table ability. A user is connected to a page like that illustrated by 018, FIGS. 8, 8A and 8C. This page allows a user to secure a table. It could be a basic table request page that just sends along the name, time and date a user wants a table like OpenTable does. Or it can be a more detailed version of this as illustrated in these FIGs. FIG. 8 allows a user to view a zoomable or interactive table floor map, and to select an exact table of choice. This would be similar to that of picking a seat on a plane while booking an airline ticket. The user can also enter the amount of guys and girls, the day they wish to come, notes, names and any other relevant information. Once a user pressed the submit button, all of the information would be relayed to exact person in charge of tables for that particular day. An average price per table and group calculator is added on FIG. 8. This would give the user an idea for what to expect to pay for the selected table, venue, party size and date of choice. As seen on the floor maps in FIG. 19, there can sometimes be over one hundred different sorts of tables to choose from. Some people might prefer to be inside, some outside, some by a pool, some in the shade, some on the first floor and some on the fifth floor, some near the DJ and dance floor, some far from there, some for two people and some for fifty people. The cost of each table sometimes varies accordingly. The user can review exact tables and prices with respect to all the other tables and floor plan of the venue. Prior to this system and platform, a person booking a table would not have the ability to know where their table was located unless they had been to that venue before and studied the floor plan. Another advantage to this is that people could use their mobile device to find friends at exact tables. Users could view maps and table numbers and see where their friends are. They could send invites to other users to join them at particular table. Table buyers will never be let down finding out their table is in the back room or not in a good location. Buyers will often will tip or pay the hosts, or get angry with them if they have a table in an undesirable location. These problems can all be solved with the addition of the table chart within the platform. Everyone will know exactly what to expect prior to stepping foot in a venue. This table securing service works for any sort of table reservation or purchase request. This platform is vast improvement to that offered by restaurant leader Opentable.

FIG. 8A is another variation of this sort of page. FIG. 8C incorporates even more abilities and information. First of all, it lists the menu and price ranges of items available. It also offers the action to Open a Communication Ticket with the person in charge for that action link, which in this case would be the head host in charge. This is shown in FIG. 20 through 21B. These sorts of pages are useful for events and promotions that involve lists and tables of any kind, even restaurants could benefit from this sort of system and platform. Users can secure tables with confidence for the first time ever. They can be directly in touch with “the” person in charge at that exact moment via text, call, email, and a concealed communication ticket that stays open until one party decides to close it, or until the transaction is fully completed.

If it were a ticketed event, a user would have the option to purchase tickets on the action page. This could be transacted by any common means. When speaking about events and promotions, often it is hard to get into a hot nightclub. A user could agree to pay a minimum amount per-person to secure entry. This is common in some cities and countries. Minimums can be in place for everyone, or just guys. They can range based on the listing partners demand. VIP entry tickets would be another action ability presented in this sort of promotional listing. People have never had a means to conduct this sort of business a their personal mobile device and companies have never had a means to promote this aspect of social life on a mobile platform. In this platform a user could press a button and immediately be connected through any desired means to perform any desired task. A developer might decide to include a popup page such as 017, 019 FIG. 8B. This page allows a user to add the event to their calendars. It also allows a user to Invite Friends to join them.

These features are first of kind in the nightlife, events, promotions, entertainment and any social activities industry. This not only streamlines coordination for users, but it also streamlines efficiency of operations for venues. It also gives both the user and the operator's access to a world of people and choices when planning or coordinating their nightlife.

Lets look at more examples. In FIG. 2, if a good portion of the member users were that select unique clientele discussed earlier, then a talent, promotions or marketing listing would be ideal for this platform. Lets say a large portion of those member users were select beautiful women, ranging from every day common beauty all the way up to supermodels. A listing partner or agent working on their behalf could list a talent offer such as that in FIG. 8D. This is a Macy's model search page. All the needed details are provided on action details page. A user could review the listing and then act. This listing might be hidden to all except the ones who fit the criteria for the search. It could be open to all, but only actable by those who fit. On this action page, a woman who met the criteria and wanted to partake in this offer would attach their portfolio and a personal intro video about themselves. After fulfilling whatever was required, they would be able to submit themselves for the offer. An array of common things could happen from this point forward such as with any job or model search. The client listing might review the submissions and request to meet in person the selected candidates. They might direct book them from within the platform or make them offer which would then have to be reviewed and accepted by the submitter. As discussed earlier, this could work for any search and for any thing, or for any offer of any kind. Another example is provided in FIG. 8E. This listing client is looking for twenty-five ladies to sing-in players and to give out gifts. They are paying $500 to $800 on average. A lady who fit the criteria would be able to attach photos and submit herself for the gig. She could also invite players who she might know. This particular client is paying a 10% referral fee to anyone who can get a friend to buy-in. This is illustrated better in the promotional version for the general user shown in FIG. 8F. A general user could buy-in; they could also donate or sponsor the LA Children's Hospital directly from the action details page. They to could invite friends to play, thereby social promoting the event for free on behalf of the client. In 2012, social marketing is the fastest growing aspect of promotions. They could also open a communication ticket to inquiry with any questions they might have. All information could be sent real-time to the listing partners who could view a constantly updating list of confirms, cancels, maybes, booked, requests, orders, submissions, accepts and denies. Any actions required by the listing partner can be transacted here with any plurality of buttons and features. Any button or needed task is placed on an action page like this one. The listing partner can monitor all of these relays from any computer or mobile device through the same platform with a few added administer features. As discussed in FIG. 1, the listing partners for these sorts of platforms range drastically. Any person, company or venue willing to offer something could be appropriate as a listing partner, particularly those looking to incentivize those select sexy, cool, hip, wealthy, powerful and affluent people. The action details pages illustrated and detailed could work just the same for work, jobs, offers, deals, paid excursions, gigs, promotions, castings, giftings, discounts, or the like. Many platforms offer deals, but none have the ability to offer these things to unique select users, or better yet, to an exact person of choice.

Another feature to mention on 014 is the center check-mark button on the bottom of the page. This is an example of a check-in button, it can also be seen in FIGS. 5B and 5C. Once pressed it will allow a user to check-in to a place. The mobile platform must be able to confirm it is somewhere before allowing a user to check-in. This is illustrated in 020, the top check-in button is available to be pressed while the other events check-ins are not. This is because the device was able to confirm itself as being at that event. This confirmation can come from several ways, the most common of which is the standard GPS check-in feature on many platforms. The problem even with the newest devices is that this method is not always that accurate. A designer might build an auto check-in, so a person's mobile device can automatically check them in to places when it can confirm they have arrived. Many companies have attempted to use geo-fencing, GPS, nearfield as ways to confirm a device is where it says it is. The problem is that devices and carriers might not have a good signal or any at all. Most companies did away with this due these troubles and gave way to bar code or in store receipt scanning to prove a user is where they say they are.

Some machines, platforms, methods and systems a designer could employee to build a superior one would be to attempt multiple GPS pulls, these pulls could be done over a specific period of time until the device could triangulate a verifiable signal. They could attempt device-to-device Bluetooth confirmations for known device cluster areas. They might ask a user to check-in to venue before entering a building that might cause signal interference. They could provide a special check-in code that only an operator might have access to until that person arrived and gave it to them, the platform could verify that code and check the device in without a signal or until a signal is verified. They could program the platform to begin specific GPS pulls a known event start time approaches. This could course out an estimated time of arrival to begin time pulling more so that the device might be able to verify its coordinates before it enters into a dead signal zone. A device might do random or specific pulls to see if a user is within check-in range of venue. They might not be aware that venue might be an available to check-in to, so an alert or could notify the user that they are at a partner venue and that its time to check-in, or that they could check-in. Any combination of these might help to serve as a superior check-in system. If all or part of this was happening in the background, and then automatically checking-in a user, that would alleviate many of these concerns. However it might not be advantageous if a developer wanted to engage users as much as possible.

Some platforms might need this verification to check-in, while other might not need to verify this. It is important in some cases. Lets look at a real life example, lets say a club was willing to pay beautiful women to RSVP and then to show up to a venue on a certain night. Once the beautiful woman arrived at the club, and stepped foot inside, the check-in button would become active. She would then be able to check-in to that exact location only. This is illustrated in FIG. 11. This check-in offers a way of double verifying someone showing up somewhere when they said they would. After the user checks-in, they might see the 021 page. This is a confirmation page verifying to them that they have checked-in. This can work for employees of any sort that are checking-in to work or jobs. This provides a digital time stamp and GPS proof that the person came to the venue. The platform can check in the background every so often to confirm how long she was there for, and automatically time stamp her in and out of the venue. This check-out aspect also works to verify duration of stay. This could be important for some businesses or jobs.

Lets fully illustrate how an offer might look from a listing partner. The offer from the club might be five dollars for RSVP'ing four or more hours prior to doors opening that night. The reason a venue would offer a beautiful woman this, is so others could see this information. If many women RSVP'd for an upcoming event and men had the ability to see this information, they would be more inclined to attend the event with all these beautiful women. This system creates something that this application calls the “hot-meter.” This first of a kind system provides a meter or indicator for what to expect prior to going somewhere. For the promotions industry, this benefit is tremendously beneficial because it can place a buzz around an event of any kind. The beautiful woman might also earn another ten dollars for showing up as planned by her RSVP. This further builds on the system of hot-meter as the live checks-in could be shown on the platform as well. This allows people to make decisions on the fly for where they might want to go at an exact moment. Then the woman might be paid another ten dollars for staying more then two hours. The longer the asset is at the venue the more money the venue is making because she is there. This directly translates to bigger sales. Overall the woman would have to perform certain predetermined criteria that would be detailed within the listing. By RSVP'ing she would be agreeing to these terms. Criteria and options will most likely vary from listing to listing partner. The reality of this is that the woman might have been doing this already, but now she is getting paid to do it because this platform linked all the necessary elements to make this happen. There could possibly be a penalization system in place for those who RSVP and don't show up. They could be charged ten dollars or some form of other penalization as illustrated in FIG. 7. This would incentivize the women or other people to follow through as planned. It also provides the ability to hold people accountable for their actions.

This location-time based incentive system is something all new and unique that can work for many industries. This is an example of crowd-sourcing for beautiful woman with disruptive technology that benefits the user, the venue, and the patrons of the night. Furthermore, by using a system and platform like this, the platform can provide a tool such as the one we call “hot-meter”; a meter or metric tool to provide people with the foresight for what to expect before going somewhere. With RSVP's, this meter works for future events, and with the check-in it works to indicate what's hot right now. This can been seen in several versions. In FIG. 5A and FIG. 17 as an upcoming party in several weeks, so a user can plan ahead. Or in FIG. 5B and FIG. 5C where a user could see where people are right now. The number 8 and 2 might indicate how many models, or how many total people are there at that exact moment. The gauge around the number could show the “hotness” in terms of a meter rather then number. This can be calculated by many factors, tables sold, RSVP's, check in's, performances, capacity, or any other. In FIG. 6 a user could see exactly who is going, who is there, and if they are members they can review others profiles. In FIG. 5B a user could see how many people are each venue nearby to them. A person could use this information to make an immediate and informed decision on where to go or book VIP services. The venue wins because they can plan accordingly plus they have more assets showing up to earn the money. Member users win because they earn money for doing something they might already have been paying money to do prior to this application. And everyone else in the world finally knows what will be hot later, tonight or right this second. This is real-time information based on factual information, not opinion. This illustrates the first conceived person meter. The platform can additionally pull check-in information from Facebook, Foursquare and any other resource to add more analytics and depth to this first of kind meter. If the member users where hand picked models, their check-in's could confirm an additional level of hotness. As discussed many times before, any party is rated mostly by how many beautiful women are there. To further describe the hot-meter and its intricacies, there are many more elements that could be updated by users such as; some users might have access to rate the venue and its party. They might be paid additional monies for doing so. Users could rate any plurality of things such as; guy to girl ratio, looks, age, race, style, music, party, vibe, energy, costumes, sexiness, difficultly to get in at door, how many open tables are there, are tables sold out, how packed the club is in percentages, or any other desired things by the designer. A user might be rewarded more for updating this information accurately. This could be measured by basing their rating off the majority rating. If the hot-meter revealed the total RSVP's, and the exact guy to girl ratio numbers, a person might be charged a monthly or yearly fee to see where all the men or women in their city where going. She might be paid extra money to allow her RSVP or check-in to be shared on her social networks. Thereby generating a greater immediate or future awareness. Generally, a single man looking for a fun night out has no idea where the majority of women might be congregating that evening. Now, if he were a paid user, he might have access to view how many women were going to each event. The meter indicated in 014 and 033 has three indicators. The center number, this could indicate any of the things mentioned above, or a combination of things. Around the number is a circular-meter, this could indicate any of the things mentioned above, or a combination of things overall. Last is the center circle color meter, this too can represent any of the values, but as color it might best be seen universally in colors ranging from green to red indicating how hot the venue is at that moment. All offerings of money might only be on a first come first serve basis, or as needed. Other venues such as restaurants might offer buy backs on dinners or drinks to those people who rate their establishments for them during set hours. So as members dine, party, drink or play, they could earn money for accurately rating the venue, checking-in, and receive these rewards via the mobile platform. This is a mutually beneficial service for all parties. The user or venue might allow this information to be shared on other social media app's and sites, allowing for an instant real-time marketing. People could check-in to any place with this platform in order to build a visual map for others to see where everyone is. This could be sold or marketed as a new age map of sorts. A people map, much like the traffic maps on GPS phones or Google Maps that indicate traffic, and this could indicate where people are centralizing. With the automatic check-in feature, it does so without draining the battery life. This is built into the platform; users can select automatic or manual check-in on their preferences.

By building a convenient mobile platform where select unique users and operators of all sorts can be combined with people and businesses willing to pay them money, an elite mobile business social network is formed. It is elite because only certain people who meet certain predetermined criteria can become approved member users. It's mobile because it's built for mobile devices of any kind. It is business oriented because it can create ways to earn money. It's a social network because it organizes people in a social way.

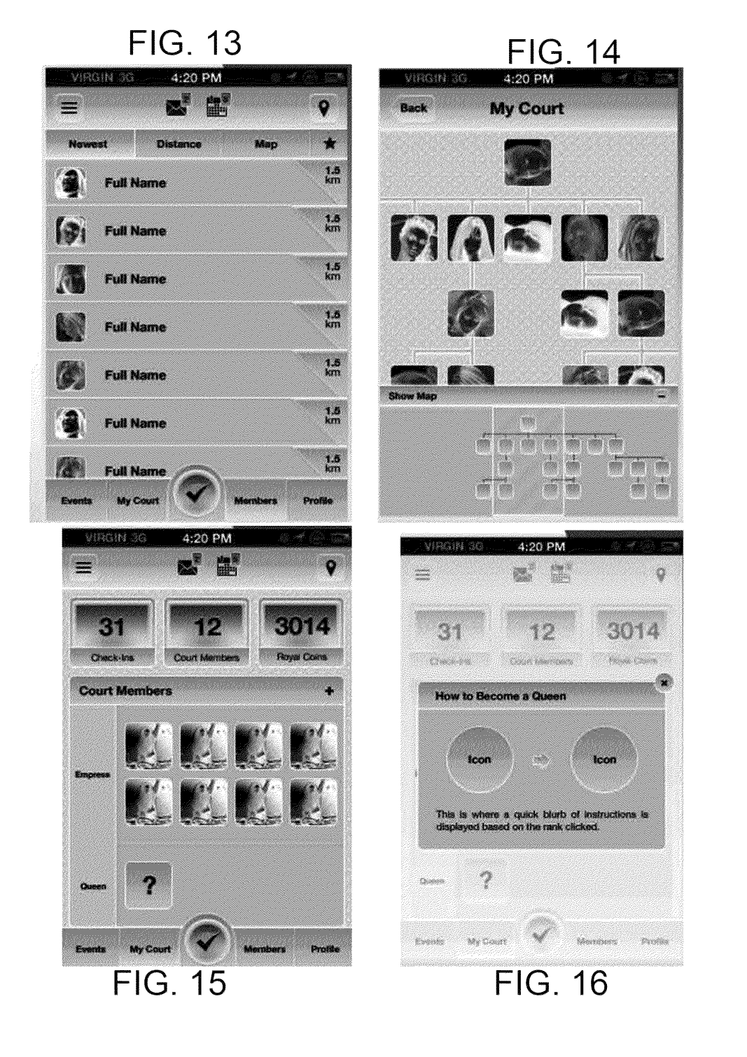

The systems, methods, machines and platforms disclosed above could sometimes be better implemented when coupled with a social network. FIG. 2 shows how this could work to improve these platforms. The platform in FIG. 2 could allow member users to browse through other users and their profiles; this is illustrated by 022 and FIG. 13. This could be similar to the view options of any social media network. Pictures, quotes, locations, display name or any other desired detail. Example page FIG. 13 offers more abilities such as view newest, nearest, and best friends. If a members profile were selected, additional information and details would be displayed in 023. Details may include more photos, current location, status, rank, and other details. 024 displays more of page 023, badges, awards, activity, count, and more community activity details. On these pages a user will have the ability to invite another user to something 025, or to message them 026. A user could also add them to favorites, or star them as illustrated in 026. The purpose of this social aspect to the platform and system is to provide the other users with the ability to persuade others to come out with them. This builds networks, friendships, and earns money for all parties involved. The major benefit of this is the ability to communicate directly with other unique select users of their peer society. This gives the users a sense of power and community within their group. This is particularly so for the users whom are getting paid to do things that everyone else in the world generally pays money to do. Going back to 014, a user can update their own profile by pressing the profile button. This will guide a user to 028 where they will have ability to view their activity, details, badges, awards, money, quotes, and any other desired areas. They can edit their own information as illustrated in 029.

We have disclosed many novel features, methods and systems within this platform, some of which can help with convenience and coordination of general peoples social activities. Others that can help unique users earn a living for doing things they love to do. We also demonstrated a system and platform that would revolutionize operations within the several industries, not only for users but also for partners, operators and venues alike. These components coupled together are impressive, but when compounded with the multilevel marketing systems and methods disclosed below, the potential for growth, revenue and income is infinite for everyone involved. Some people might think of this as a perpetually paying leveled referral system.

We are going to look at an element that could be part of a platform and system like the one in FIG. 2. This additional system added to the disclosed systems is sort of like a turbo gear sprocket on the platform. It has a multilevel marketing element to it. Before we look at the platform in FIG. 2, lets discuss how this additional system and method could work in with what's already been disclosed. Every beautiful girl knows several other beautiful girls. Models are always around other models at castings. Actors are always around other actors. Beauty usually attracts beauty. Lets discuss a platform and system where the only member users accepted are beautiful women and celebrities. Current members, or these beautiful women and celebrities could submit their beautiful and celebrity friends to be reviewed for membership approval like they were. The unique part about this is that the platform and system itself is used as a mobile scouting service for itself, rather then for others as described earlier. If these friends are accepted, then they are placed underneath the friend who submitted them, this is illustrated in 031, 032 and FIG. 14. Much like any pyramid, referral, scheme, or multilevel system would work. When someone who is underneath a user makes money, some portion or percentage of the money is can be paid up. In this way, the friend who submitted someone is getting paid from his or her friend's activities. If this new friend below submits a friend of their own who becomes accepted, then they to pay up the ladder or tree just the same, so on and so forth. This is an ever-growing community of select unique users who are all paying up to those people above them. This encourages everyone to scout for other member users to grow their own business as well as the overall platform, systems and methods.

The system and exact structure could be handled like a typical pyramid or it could be modified to work for each industry that it's built for. Now the members of this platform are not only earning money for themselves, but they are earning it by recruiting others to get paid for doing things they love doing too. In essence this platform unionizes and mobilizes select unique users by incentivizing them. It can unionize any group of people, but is particularly efficient for beautiful women, tastemakers, socialites and celebrities. This first of a kind system and platform can also work for many groups or industries. Some beautiful women might just hear about the platform and submit themselves. By doing so they would be starting their own tree with no one above them. In some platforms it might be mandatory that everyone to have someone above them like a big brother or sister of sorts. For the women who get their girl friends in and under them, they can build this network or pyramid like it was their own private royal court of ladies. This is illustrated in 030, 031 the network overview, and 032 the map view of a users court. A user could select another member user to check their activity and see what they are up to and what events and monies they have been earning for both themselves and for their higher ups. More court activity is illustrated in 030 and 033. A close up screenshot mockup view is illustrated in FIG. 15. A user could see everyone below them, see exactly what they up to, message them, invite them, and watch the money being earned by having a court of beautiful ladies under her command. There could be ranks and levels associated with this hierarchy. Some example levels might be ladies, duchesses, princesses, queens and empresses to name a few. In 034 a user could view what she might have to do to be upgraded to a higher rank. FIG. 16 shows this more clearly. This might consist of building their network to a certain number. It could happen after achieving badges or possibly a combination or things. The difference in rank could offer more privileges. It could have higher payout structures. It could be just bragging rights. There are countless iterations to this system. The core of it is to build your network to make more money. The menu button on 030 could direct a user to a common menu slide out shown as 035. There, users can search 036, find events attending by them and all their court 036, messages and notifications with other user and listing partners 038 and 039, account settings 040 and 041 with privacy settings, they could send feedback, invite more friends to join, or any other desired features.

This system along with the others systems and methods disclosed can work in betterment of one and other. The systems combined could earn member users some serious money everyday for doing nothing more then what they already love doing. People could for the first time be paid from utilizing their networks without the need to sell or buy anything. In this system people themselves are talent scouts. If someone under them books a commercial or modeling gig that pays big money, like any manager or representative, they would earn a percentage of that job. People all become accountable to one and other to help each to earn a living.

More then that, this system takes the money out of the hands of those people who historically shielded these select unique people, and it puts that money directly into the hands of the people who deserve it. It puts it into the assets hands, more clearly, the select unique members hands. Money is a great incentive, but there are other ways to pay people, particularly to those who have lots of money. There are all kinds of thank you incentives that have been conceived through the years. From deals, to discounts, to free things or comped things, to vacations, to meals, to gifts, to anything. The biggest incentive that is offered by this platform and system is the ability for others to be untied with their peers. This core group of select unique people are sough after, and they often find it hard to meet people they admire, regard or desire. These select unique people are generally uncommon and hard to come by, that's what makes them unique. Now there is hand picked select network where these people can congregate and interact free of fear that they are alone or different. This was the original conception behind my social networks such as Facebook, but these companies learned it was best to allow everyone in. For many of these systems, methods and platforms, its selectiveness is what makes it superior to other businesses. This particular system might not prevent anyone from joining, but it might just finds ways to unite people with others who are willing to incentivize them, and because it can isolate them and connect them.

Most of these processes could be managed by the platform if so desired. From the selection of members, to processing of their personal information, to the selection process it self, to the posting of listings, to coordination of the offers, to billing, to payments, to analytics, to relay of communications, to operations and to any other desired ability. Details within listings could be updated in real-time by operators, venues, employers or any other determined administrator. Administrators could have the ability to do this from within the platform or through a web portal, or another portal. FIG. 11 is mockup screenshot of a create or update page within the mobile platform. A determined admin could add or update any details to any listing in real-time and on the fly from anywhere. The member privileges could vary for each and every person. This could be automated by the system and changed and controlled by its administrators. The details for any listing offer, be it a job, a gig, travel, a deal, a discount, whatever could be entered on a scaled up version of this page. Jobs like acting, modeling or even a secretary position at a company, could all be detailed or designed to be as specific as needed for the listing to be effective for all parties. The tabs that could be added could range from a plurality of things with a linked option. Any desired tab could be linked to a plurality of desired effects.

Within many of the disclosed systems, methods, machines and platforms, there might be an element of connecting people. Whenever connecting strangers with one and other for business or personal reasons, there is some exchange of personal details or contact information that is transferred or revealed. With the digital age, every aspect of people's lives is becoming free and common information. One of the major goals of this application is to provide systems, methods, machines and platforms that can work using a concealed communications. This is to limit the revealing or passing along peoples personal information. This is illustrated in FIG. 20, FIG. 21, FIGS. 21A and 21B. In essence, when a person desires to contact another person via a platform described within this application, they will have the ability to conceal their personal details, and or contact details. This is accomplished using a central hub as a transmission relay system. As a user attempts to communicate with any other user, this communication is transmitted to a central communications hub as shown in User 1 box on FIG. 20. This message is then given a unique ID tag. It is then transmitted to the desired person via the platform and or any other desired traditional means such as SMS, MMS, email, call or message with its unique ID, shown as the Relay Hub in FIG. 20. This message can be read and responded to via the same means it was received or sent, as shown in FIG. 20 as User 2. It's easiest to think of this a thread of communication. If the message is transmitted via email, the subject keeps a thread or chain of messages together for each party to respond to. This works just the same. The unique tag is the linking thread like a subject field might be for an email. As a person responds it is transmitted back to the receiving party revealing only the information a person provided within the message. The tag could be a random temporary ID or it could be a user specific number as AS13 illustrated on FIGS. 21, 21A and 21B. The system could be built to remove or block any users personal details if desired. Such as emails address, numbers, signatures, or any other details.

A major component to discuss is the accounting for each member and business from a financial aspect. If this system is partially designed to earn people and companies money, then it should have an ability to simplify these things. With that, it has an analytical aggregating accounting and billing system built into the platform. This process is simple, as an example a user accepts an offer from a listing partner, or they refer some business, or they earn income in any way from the platform. This money accrues in a member account; this is shown in FIG. 15 as Royal Coins or Royal Credits. The member's activities and earning are kept in this account, just like the accounts kept for models and actors at any agency, management or legal firm. All invoicing and billing to any listing partner is handled electronically and automatically by the accounting system. The member could cash out these earning at any point if desired, or could use them to purchase things. The developer might set some predetermined criteria such as a minimum cash-out amount, or an automatic monthly payout, or weekly, or whatever was desired. The platform could be setup to pay people automatically and electronically. Their account could be linked to any other account and credits or monies could be electronically transferred. An example would be linking a PayPal or bank account to the members account. The money held for the member might be kept in an interest bearing or investment account that could act as a common account with typical privileges, like debit cards, checks, or any other common thing. There could be a very simple system where members earn credits or coins instead of money. A person could convert these credits or coins to any currency they desired. The conversion rate could be any desired amount set by administrators. Another obstacle this allows users to get around is Apple's App Store partnership charges. Apple charges thirty percent of any monies made through an app they allow in their store. By using credits instead of actual dollars, you can avoid having to pay Apple for this steep charge.

An interesting area to discuss is the possible solutions for paying out this currency in newfound ways that could excite people. Once a person is accepted to become an earner on one of the platforms disclosed, they could be given an account. This account would have a loadable and chargeable card linked to it. When credits or coins are converted to currency, that currency could be loaded onto a card that works like any normal ATM, debit, and credit card. This account might have checking, saving, and bill pay capabilities like any normal account. A user would not be required to do all that much to have the luxury of getting paid by a mobile app. A beneficial point to disclose is the ability to give people branded cards to use. These cards could have a company's logo on it, so as people are out spending money, they are branding the company as a company that pays people for doing things they love. This system might avoid many typical tax implications that could be overwhelming with a platform like these. However payout is handled, the member is paid out from the platform. The platform and system deals with electronically collecting all monies owed to members. This is all agreed to in contracts with each listing partner prior to posting any listing. So members don't ever have to deal with chasing and collecting monies.

These days, the hardest part of working in the nightlife and talent industries is tracking all of these details from one employee to the next and more so collecting the monies owned to you. Someone once said, in order to be paid in these businesses, you must act like a mafia boss when its time to collect any money owed to you. The jobs, tracking and billing is far easier and more efficient when its digitized tracked this way. For the first time ever, models could work without fear of never being paid, actors could be paid fast, and operators in nightlife would be paid without having to stalk, harass and sue people and companies. Some people within these industries might view this as being the greatest part of these platforms. This is only because they have dealt with these problems over and over again and have learned that sometimes, you just don't get paid for your hard work. This instantly gives operators the option to work for hundreds of employers all at the same time with out ever having to do anything to have this ability. This same concept is illustrated in many different forms to show the diversity of this sort of platform for any system, method or business. Particularly for any sales or referral type business.

The method of adding this automatic and electronic system to a platform like that illustrated in FIG. 2 is revolutionary for many reasons. Lets discuss some of them. Working in the nightlife business, operators often refer and send clientele to places they don't work. They do this so they can build service relationships with this clientele. Table buyers often ask a host they like to deal with to set them up with a table at a venue they don't work at. Operators generally hate doing this because usually there is no way for them to get paid for their efforts, but also because they are giving away their client who could be poached by other hosts. This can lead to someone stealing his or her client. This is called poaching in the industry. This business by nature is a social one where everyone attempts to know everyone. Operators in the business are constantly trying to steal everyone's contact information so they could wrangle them. So to say who directly brought someone to a venue is sometimes hard, as several people might have invited any one person. More so, it has become ever increasingly harder to collect money for referring business to other venues. These problems have grinded away at and slowed the growth of the business as a whole, on both personal and corporate levels. Operators will send their clientele to venues that are more likely to pay them versus others who might be hard to get paid from or not pay at all. With a platform like this, any operator can send a table, or clientele to another venue and have a means for tracking it and have confidence he or she will be paid for referring this business. Historically, the only other way an operator could be paid for sending their business to another venue is if they had verbal or written contract with that other venue. Any one person can only have so many contracts or relationships with venues. These are limited to a persons network and channels. A person's options for referring business to other venues out of town or out of state is limited or nonexistent. With this system and platform, any operator, or any person for that matter could send clientele to any venue, and know for certain they will be paid for it. The designer and administers of the platform could arrange a standing deal with each listing partner venue for any and all sales transacted through the platform. Someone sends a table to a partner venue; there is a digital trail and proof of where it came from and who sent it. The platform designers invoice the venues for sales referred. Then they deal with collecting the money on behalf of the person who submitted it. Then the platform designers pay the person their referral commission according to their predetermined deal. The venues get more business this way. The operators have access to any venue in the world. No one has to deal with tracking sales because it is now digitized. Money is trailed and paid out without any problems. This is a new improved efficient system and platform for coordinating nightlife. People can be accounted for. People's effectiveness now has an exact number to which can be tracked in the platform. Venue owners, or higher up operators can access the analytical information behind where sales are coming from, who is performing and who is not. For the first time they have clarity into their operations. They can use this information to decide who should be paid and exactly how much they should be paid. Everyone makes more money with this system and platform. All of these things are beneficial to users, operators and venues. The platform designers may choose to take a percentage or a fee for transacting these operations. This sort of infrastructure never existed in these industries.

On the RSVP side of this, the same rules apply. Operators can have access to the first real-time mobile guest list because people are RSVP'ing and being held accountable for it. This is relevant information for the venues. It is constantly updating itself and operators can know exactly what to expect many hours prior to opening their doors. If there are a lot people coming out that night, they might staff up more employees, or vice versa, they might cut employees if they have the knowledge it was going to be a slow night. The informational clarity and foresight with this system can save and earn big dollars for all parties involved and it gives the end user a much more efficient, effective and satisfied experience.

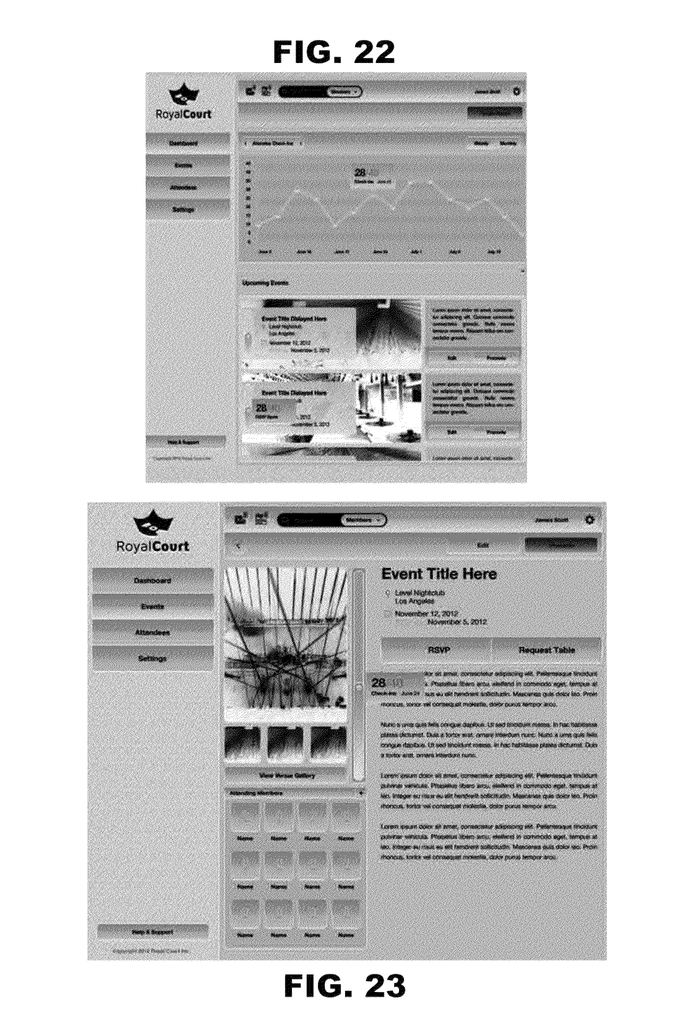

Some of the informational clarity can be seen in FIG. 22 and FIG. 23. An owner or manager level operator could view the overall analytics for their venues. They could view who RSVP'd, who showed up, they could track these things and view who sent in business and how much. They could view active and live guest-lists. They could monitor and oversee events and tasks that where never possible before. The real-time cloud guest-list could be checked and confirmed by door people using the list system. People can be counted and accounted. How many people each RSVP'd person brought with them could be added to this dynamic list with how many guys and how many girls. Venues would know who their best customers were for purposes of rewarding them. This live cloud like guest-list is ideal when combined with accountable RSVP's and check-ins. These new and first of a kind features will allow users and operators to know many hours before arrival how many people are going, how many tables are sold, what the capacity issues will be, and many other analytical clarities previously unheard of within this industry. A user could RSVP or Secure a Table in FIG. 23. They could also see other attending members could be viewed in the Attendees tab. Past events and analytics could be viewed as well.

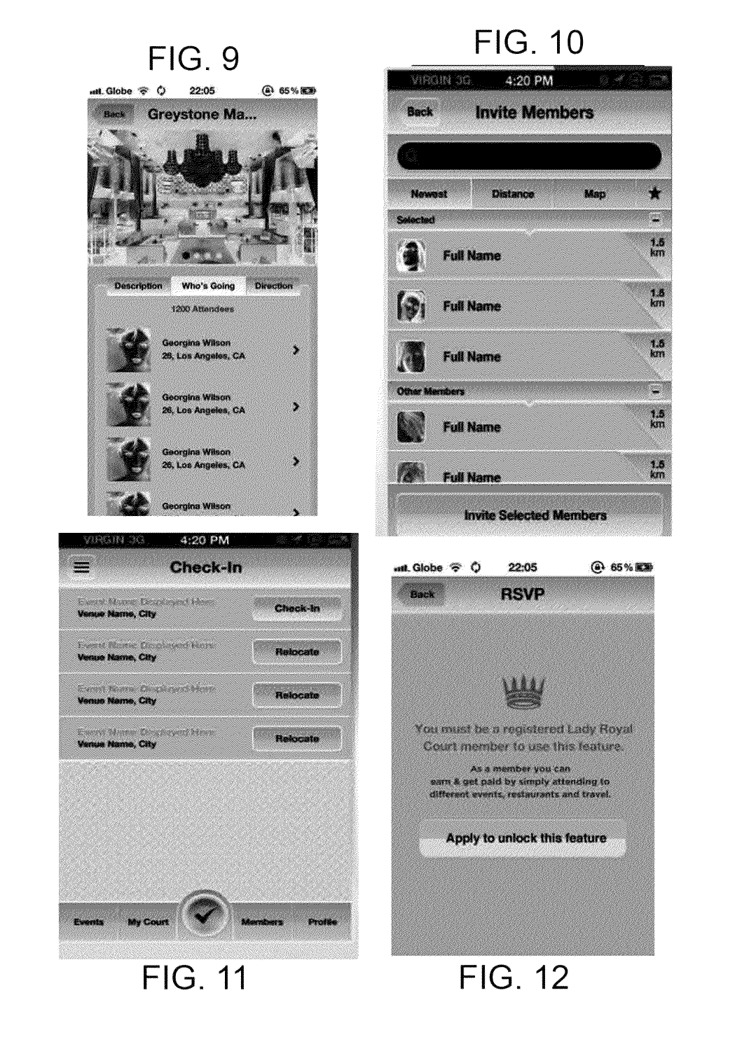

The social marketing available in a platform like that of FIG. 2 is revolutionary. The hot-meter is a great tool that operators could share, post or use on any source. The live check-in added to this increases its accuracy and strength. Something else to discuss in the social marketing aspect of this application is its users ability to promote things. When a person RSVP's for an event, or books a table somewhere, or when they find something that interests them, they will have the ability to share that with friends. This is illustrated on FIGS. 8B, 8E, 8F and 10. A user could press the invite button and share the event with friends on platform, or with friends on any other platform linked to this one. They could share it on their Facebook, they could send the listing to friends in their phonebook, they could tweet it, and they could share it anywhere. By doing so, they are promoting things for free. Some listing partners might incentivize users to share the listing. They might pay one dollars per friend shared with for example. These shares would be far more valuable if the platform where one consisting of select, unique, users. These sought after people opinions and lives are generally followed by many. There are companies that pay these types of select unique people big money for tweeting and sharing their corporate information. This would be grand scale of that model but built into a social network. An additional aspect to this tool is illustrated in FIG. 9, the who is going table on an action details page. A member user might be able to see an exact list of who RSVP'd, this can help for operators, but it can also help friends make more informed decisions on where they want to go. This is another form of social advertising.

If a good portion of users on platform like this were that select unique type of person, then security and privacy are huge. Many people of noteworthiness do not want anyone knowing or seeing any personal information about them. This is why most famous people do not have a Facebook. This is why they don't give out their phone number and used blocked calls to protect their number. In these platforms, users have the ability to control every aspect of their information and profile. Including their whereabouts and movements within the system. Examples of this are illustrated by 040 and 041 in FIG. 2, the setting pages. Users can hide or show all aspects of their profiles. They can also set how others can contact them, if at all. They can use the concealed communications system in FIGS. 20, 21, 21A and 21B. This would protect the users name and info from ever being revealed to anyone, unless they personally chose to reveal it. This sort of functionality is why a celebrity, a person of power, or a beautiful women might feel comfortable trusting and using a platform like this versus a public one like Facebook.

Another feature to disclose within this section is the proximity alert. A user could find a friend from within the mobile platform that would have a proximity sensor to help find tables or friends within an event. With a table floor map and numbers, users would know exactly where to find their friends. Google maps recently added an indoor mapping feature to help people navigate through indoor places. It could work in conjunction with Google indoor maps or be its own integrated feature.

While the above description contains much specificity, these should not be construed as limitations on the scope of any embodiment, but as exemplifications of the presently preferred embodiments thereof. Many other ramifications and variations are possible within the teachings of the various embodiments. We will discuss a few other embodiments or ramifications that could be used as standalone or added features to these systems and platforms.

For example, a wingman design or feature as a standalone or added element to the platform. The term wingman is defined as a guy or girl who is a friend to another individual, but for the purposes of this application it is a person who is hired to be a wingman for specified length of time in order to help the person who is paying look cool, or pickup on an other third party person or persons. In layman's example will be illustrated here, a guy hires a hot girl to go out with him in hopes that the hot girl will talk him up to other potential hot ladies. There is a general rule of thumb in human interactions, that a lady always feels more comfortable talking to a man she just met when other pretty ladies are around him. It makes the new women feel a sense of comfort and wonderment about this new man. Who is he, why is he with all these beautiful ladies, I want to get to know him more and see what he is about. This is such a common ideal that some websites and women offer this service for an hourly or nightly fee. Some earn fifty to a thousand dollars a night. This is not an escort service and no sexual or strange acts are permitted. These sorts of acts are strictly prohibited and both parties know exactly why they are there. If a person wants an escort, they can hire one. That is a very different business. Many girls and guys make a good living do this. They also help teach the clients the best strategizes for picking up a hot date. There was movie with Will Smith titled Hitch that was based on a wingman. This sort of element or feature combined into the disclosed systems and platforms could serve as an additional revenue stream for the member users. It could also work as a standalone platform and system of its own. For the user members that wish to be part of this, they could have that feature reviewed and visible to them within the platform. Clients could request a user member to join them on for a night out, dinner, event, party, weekend, or anything of their choice. The user could review the profile of the Client and communicate with them if they chose to. After that they could accept the offer or deny it, all from within the system. All coordination could be transmitted through the platform along with billing and payment from both parties.

An area we briefly discussed but would like to disclose more about is the sales force potential. Every product in the world needs to be sold, even food that we need. Many dollars are spend on the best sales strategizes and campaigns. Another costly expense is your sales team. These people generally make commissions or referral fees for sales. Imagine a sales force or team of hundreds of beautiful people selling your product, or pushing your venue. In a system where the select unique people consisted of beautiful people, or beautiful women, the upside is clear. People to tend to listen more to beautiful people, they are less apprehensive or more prone to buy something from someone who is good looking. For businesses with products of beauty, fashion, taste, style, health, good-looking people rule these realms in advertising. This is because image is everything in sales and style. For a product like this, a sales team of thousands of beautiful people pushing a product for cut of the sale working indirectly for a company could be massive. The company does not have to hire, train, teach, or provide for the sales team, but yet they are out there pushing products and referrals through a mobile platform. The image of the product and the people representing the company changes dramatically from your standard case. Lets look at a real life example.

A company like LaserAway LLC provides Botox, laser hair and tattoo removal, body sculpting like Lipo and things, and other mostly female driven products. LaserAway is the number one distributer of Botox in the world, of which more then ninety-percent of is used by women. Many women at one point or another try or use products that a business like LaserAway offers. Most of their revenue is derived from word of mouth and sales reps that are all paid percentages of the total sale referred. If LaserAway was a listing partner on a platform like this, they could offer the sales team who might be a group of select unique beautiful women, twenty or thirty percent of all sales referred by the unique members. A member user could enter a friends or persons phone and or email along with name and other details and pass it along to LaserAway, and vice versa. When the friend or person gets any treatments done at LaserAway, the portion of sales is paid the unique person who referred the business in perpetuity. This model could be reproduced for any industry that deals in referrals or sales.

Another embodiment or ramification that could be used as a standalone or added feature to these systems and platforms is the ability to post listing for paid or free vacations for those select unique users.

Dating is big business both online and in the mobile world. Sites like JDate.com and others like it attempt to unite people of similar backgrounds, groups or likes. For the platform and system disclosed in this application is far superior because it has the ability to select unique users. Most dating systems ask people for personal details or elements about themselves and use these details to match people. The major difference that is capable as a standalone or addition to this system is the fact that everybody would have to submit him or her self for review. If they are approved into this elite or exclusive community, then they will have access to all other members within. With this access, members if desired could have the ability to mingle and connect via the platform. During events and mixers they could casually meet or get to know one and other while being in public places with other friends and peers. This is not only an icebreaker but a knew way to get to know others in a comfortable and pre screened setting. Every person accepted as a member will have to disclose particular details and references that allow a new level of awareness and trust before ever meeting another person. This is very similar to many high-end private clubs. There are matchmaking services that deal in similar manners, but none have the ability to do it on a grand scale and with a platform quite like this. The membership criteria's for this platform are more focused on the select unique peoples discussed in this application. These select unique people 1640 being mostly beautiful women, the tastemakers, the socialites, the celebrities and the rich and powerful to name a few. These circles of people have never been brought together with a system and platform in order to allow them the ease of meeting their peers. In fact, these sorts of people generally have the hardest time finding and connecting with their peers then any other group in the world. These people are generally guarded and protected by gatekeepers whose job by nature is to isolate them. This system and platform allows users have a gatekeeper with the platform but yet have access and direct communication to others like them.

Users can submit themselves to be part of any portion of the platforms disclosed or all of them. Some users might be approved and granted access to particular portions of platform but not to others. An example of this is illustrated in FIG. 12. This can be controlled and updated via the platform, and backend of the system if needed. Each person's privileges could vary for each industry. Such as, maybe actors are only placed with other actors or other entertainment people. They are connected with their peers so that they can mobilize as one powerful group. Or a platform can be designed to operate with a pool of these different select unique peoples in one platform and using one universal system. Linkedin.com attempts to unite people of all kinds with references from others in the form of invites. These systems and platforms could be run more like the private high-end social clubs in today's world. A ramification of this conceived could be a modern technological version of the Freemasons or private societies of sorts. A group beyond groups sort to say.

Another ramification to disclose is a system of bartering within the platform. Digital bartering is big business online. There is even a mobile bartering app. There are time-share bartering systems as well. But none of these systems have built a bartering system within a select unique user community. The select unique users discussed within this application are generally the wealthiest, most powerful, and most influential people. Their assets in material things are generally greater then those of the average person. More so, their person, or likeness is valuable commodity as well. Not only for commercial purposes but also for politics and public awareness. A community of select users able to congregate powers and services through the use of a platform and system has never been designed. The platforms and systems behind this application do exactly that. The added elements and features are simply more ramifications available to attract or build users and members.

It is important to understand that many new tools, features, abilities and concepts are disclosed individually within this application. They are often spoken about in conjunction with others to show how one can help improve the other. These new tools, features, abilities and concepts are each novel in and to themselves and could be used as stand alone operations or compiled into one big platform with many usable features and functions for the broader markets, such as FIG. 2.

The reasons for paying select, unique, people to come places or do things are limitless. That is one of the elements behind many of the features of all of the platforms, systems, methods, processes and machines disclosed within. Everyone on the planet can appreciate beauty in many aspects. This system helps bring together those individuals of power, frame, wealth, smarts, success, style and brings them all together into one innovative community in efforts to connect and unify them so everyone can expand their networks for both personal and business matters. Using these platforms, systems and methods to earn income and enjoy a more simplistic and better quality of life is this applications goal.

In conclusion, this is a new business method that combines unique systems, methods, processes and machines with exclusive platforms to earn revenue while making people lives easier. The variety of components within the platforms, methods, processes, machines and systems makes it diverse in scope and broad in range of appeal. This is to attract users of all kinds. The addition of a multilevel-marketing aspect reinforces and compounds its power to earn users an income in an all-new manner. The system and platforms ability to isolate and bring together select unique people is what makes it stand out from all other businesses. Most of all, its ability to bring all of these people, businesses and revenue streams together through a platform with a mobile based counterpart is what makes it unique.

The major focus of this application is placed on mobile platforms with systems, methods and machines to support those platforms. This is because in coming years most human interactions will be centered around these ever shrinking and user friendly mobile devices. Cost of data transmission and the amount of information contained on websites is what prevents mobile devices from working as traditional computers would online. As data transmission rates improve, and web pages become more mobile friendly, maybe one day there will be no need for device apps and platforms like the ones disclosed within. That is the reason a regular mobile friendly web counterpart is disclosed within this application. It is important for all businesses to investigate any potential revenue aspect and to be ahead of the curve.

Although the description above contains much specificity, these should not be construed as limiting the scope of the embodiments but as merely providing illustrations of some of the presently preferred embodiments. Many other beneficial results can be attained by applying the disclosed invention in a different manner or by modifying the invention as was described to show several possibilities.

The scope of this application should not be determined by the examples given but by the appended claims and their legal equivalents.

It is claimed:

1. A system for incentivizing the activities of a plurality of individuals comprising, running on a digital computer system having a processor, a database, and a communication system:
a) a module for accepting, and adding to a database, individuals' identity and contact information, as well as personal characteristics regarding the individual;
b) a module for receiving an offer and posting it electronically to at least a subset of individuals in the database, the offer including a location, date, and time at which the individuals are incentivized to be present and also including the terms of a positive incentive to be provided upon acceptance and subsequent personal presence as specified;
c) a module, operated on a mobile electronic device, for displaying visible offers and allowing acceptance;
d) a module, operated on a mobile electronic device for verifying compliance with accepted offers.

2. The system of claim 1 where the terms of the incentive include a penalty for not being present as agreed in an accepted offer.

3. The system of claim 1 where the terms of the incentive require personal presence within a range of the specified location for a minimum amount of time within a specified window.

4. The system of claim 1 where the incentive is non-pecuniary and comprises at least one of: complementary admission, complementary food and complimentary drink.

5. The system of claim 1 where the incentive is pecuniary and comprises points that may be optionally redeemed for money.

6. The system of claim 5 where the redemption is via a debt card.

7. The system of claim 6 where the debit card also serves as an element in a closed-loop presence verification subsystem.

8. The system of claim 1 where the location is a business serving food or drink.

9. The system of claim 1 where there is electronic verification of agreed-upon personal presence.

10. The system of claim 9 where the electronic verification comprises GPS locating.

11. The system of claim 9 where the electronic verification comprises cell-phone photography.

12. The system of claim 1 where acceptance is only operative for individuals who have personal characteristics indicated in the database that are compatible with those required by the offer.

13. The system of claim 1 where offers are only completely visible for individuals who have personal characteristics indicated in the database that are compatible with those required by the offer.

14. A method of facilitating selective product placement gifting comprising:
a) entering into a computer database the identity, contact information and personal characteristics of a plurality of individuals;
b) receiving and posting electronically, a product promotion offer to a limited number of individuals within the database who posses personal characteristics specified by the product placement offer such as to be visible only to those individuals.

15. The method of claim 14 where the number of total items to be gifted is less than the number of people with criteria-meeting personal characteristics and the actual gifting is by earlier acceptance having priority over later acceptance.

16. The method of claim 14 where the personal characteristics comprise listed names.

17. A system for incentivizing people to join them at a venue comprising:
a) a module for accepting and adding to a database, individuals' identity and contact information, as well as personal characteristics regarding the individual;
b) a module for receiving an offer and posting it electronically, visible only to a subset of individuals in the database; the individuals having personal characteristics stored in the database consistent with criteria present in the offer; the offer including a business location and a stated incentive to patronized the business; the offer further including a compensation to the accepting individuals to post, on a social media site, the timing of their plans to patronize the business and including an identifier allowing unique tracking of people influenced by particular acceptors to patronize the business during a time window indicated in the social media post.

18. The system of claim 17 where the tracking of influenced individuals is used to determine at least one aspect of the acceptor's compensation.

19. A mobile electronic communication and computer device having a screen, a CPU, memory and radio frequency communication circuitry programmed to perform the following steps:
a) receive data from a user comprising, identity and answers to predetermined personal characteristics questions;
b) transmit that data to a remote computing and storage facility;
c) receive, from a remote computing and storage facility, an offer that is being directed to the user due to a detected correspondence between the users' pre-entered personal characterizes; the offer relating to an incentivized request for the users' presence at a prescribed time and place
d) receive from the user, an acceptance of the offer;
e) transmit the acceptance to the remote computing and storage facility.

20. The mobile electronic communication and computer device of claim 19 further programmed to indicate a dis-incentive for accepting an offer and subsequently not fulfill the offer by being personally present as agreed.

21. The mobile electronic communication and computer device of claim 19 further being configured to participate in an automatic, electronic versification of agreed-upon personal presence.
